(19) United States
(12) Patent Application Publication
(10) Pub. No.: US 2023/0316071 A1
(43) Pub. Date: Oct. 5, 2023

(54) NEURAL NETWORK GENERATING DEVICE, NEURAL NETWORK GENERATING METHOD, AND NEURAL NETWORK GENERATING PROGRAM

(71) Applicant: LeapMind Inc., Tokyo (JP)

(72) Inventors: Koumei TOMIDA, Tokyo (JP); Joel Owen NICHOLLS, Tokyo (JP)

(21) Appl. No.: 18/013,162

(22) PCT Filed: Jun. 30, 2021
(86) PCT No.: PCT/JP2021/024836

§ 371 Date: Dec. 27, 2022

(30) Foreign Application Priority Data
Jun. 30, 2020 (JP) 2020-113315

(51) Int. Cl. G06N 3/08; G06N 3/04

(52) U.S. Cl. CPC G06N 3/08; G06N 3/04

(57) ABSTRACT

This neural network generating device for generating a neural network execution model for computing a neural network is provided with: an execution model generating unit for generating the neural network execution model on the basis of hardware information relating to hardware on which the neural network execution model operates, and network information relating to the neural network; and a learning unit for generating trained parameters of the generated neural network execution model.

### TECHNICAL FIELD

The present invention relates to a neural network generating device, a neural network generating method, and a neural network generating program. The present application claims priority on Japanese Patent Application No. 2020-113315, filed on Jun. 30, 2020, the entire content of which is incorporated herein by reference.

### BACKGROUND ART

In recent years, convolutional neural networks (CNNs) have been used as models for image recognition and the like. Convolutional neural networks have a multilayered structure with convolution layers and pooling layers, and require many operations such as convolution operations. Various operation techniques that accelerate operations by convolutional neural networks have been proposed (e.g., Patent Document 1).

### CITATION LIST

### Patent Documents

[Patent Document 1] JP 2018-077829 A

### SUMMARY OF INVENTION

### Technical Problem

Meanwhile, image recognition or the like utilizing convolutional neural networks is also used in embedded devices such as IoT devices. A generating method for generating neural networks (models or circuits) adapted to the hardware configurations of embedded devices are sought in order to efficiently run convolutional neural networks in embedded devices. Additionally, in the process of generating neural networks, a method for training neural networks that makes neural networks run with high performance using the limited hardware resources of embedded devices is sought.

In consideration of the above-mentioned circumstances, the present invention has the purpose of providing a neural network generating device, a neural network generating method, and a neural network generating program that are embeddable in an embedded device such as an IoT device, and that generates a neural network that can be made to run with high performance.

### Solution to Problem

In order to solve the above-mentioned problems, the present invention proposes the features indicated below.

A neural network generating device according to a first embodiment of the present invention is a neural network generating device that generates a neural network execution model for operating a neural network, and is provided with: an execution model generation unit that generates the neural network execution model based on hardware information regarding hardware in which the neural network execution model is operating and network information regarding the neural network; and a learning unit that generates learned parameters of the generated neural network execution model.

A neural network generating method according to a second embodiment of the present invention is a neural network generating method for generating a neural network execution model for operating a neural network, and includes: a hardware information acquisition step for acquiring hardware information regarding hardware in which the neural network execution model is operating; a network information acquisition step for setting network information regarding the neural network; an execution model generation step for generating the neural network execution model based on the hardware information and the network information; and a learning step for learning learned parameters of the generated neural network execution model.

A neural network generating program according to a third embodiment of the present invention is a neural network generating program for making a computer generate a neural network execution model for operating a neural network, and includes: a hardware information acquisition step for making the computer acquire hardware information regarding hardware in which the neural network execution model is operating; a network information acquisition step for making the computer set network information regarding the neural network; an execution model generation step for making the computer generate the neural network execution model based on the hardware information and the network information; and a learning step for making the computer learn learned parameters of the generated neural network execution model.

### Advantageous Effects of Invention

The neural network generating device, the neural network generating method, and the neural network generating program of the present invention are embeddable in an embedded device such as an IoT device, and can generate a neural network that can be made to run with high performance.

### BRIEF DESCRIPTION OF DRAWINGS

FIG. 1 is a diagram illustrating a neural network generating device according to a first embodiment.

FIG. 2 is a diagram illustrating inputs to and outputs from an operation unit in the neural network generating device.

FIG. 3 is a diagram illustrating an example of a convolutional neural network.

FIG. 4 is a diagram for explaining a convolution operation performed by a convolution layer in the convolutional neural network.

FIG. 5 is a diagram illustrating an example of a neural network execution model.

FIG. 6 is a control flow chart of the neural network generating device.

FIG. 7 is a timing chart indicating an operating example of the neural network execution model.

FIG. 8 is a diagram for explaining data partitioning and data expansion in the convolution operation.

FIG. 9 is a timing chart indicating another operating example of the neural network execution model.

FIG. 10 is a diagram illustrating a partial tensor obtained by tile-partitioning output data from a convolution operation.

FIG. 11 is a diagram illustrating a partial tensor obtained by slice-partitioning input data.

FIG. 12 is a diagram illustrating a partial tensor obtained by slice-partitioning input data.

FIG. 13 is a diagram illustrating a partial tensor obtained by slice-partitioning input data.

FIG. 14 is a diagram illustrating a partial tensor necessary for outputting another partial tensor by a convolution operation in layer (2M+1).

FIG. 15 is an internal block diagram of a generated convolution operation circuit.

FIG. 16 is an internal block diagram of a multiplier in the convolution operation circuit.

FIG. 17 is an internal block diagram of a multiply-add operation unit in the multiplier.

FIG. 18 is an internal block diagram of an accumulator circuit in the convolution operation circuit.

FIG. 19 is an internal block diagram of an accumulator unit in the accumulator circuit.

FIG. 20 is a state transition diagram of a control circuit in the convolution operation circuit.

FIG. 21 is an internal block diagram of a generated quantization operation circuit.

FIG. 22 is an internal block diagram of a vector operation circuit and a quantization circuit in the quantization operation circuit.

FIG. 23 is a block diagram of an operation unit in the vector operation circuit.

FIG. 24 is an internal block diagram of a quantization unit in the quantization circuit.

FIG. 25 is an internal block diagram of a generated DMAC.

FIG. 26 is a diagram for explaining a scaling factor in a quantization operation.

FIG. 27 is a diagram for explaining a scaling factor in a quantization operation.

FIG. 28 is a diagram for explaining a scaling factor in a quantization operation.

### DESCRIPTION OF EMBODIMENTS

### First Embodiment

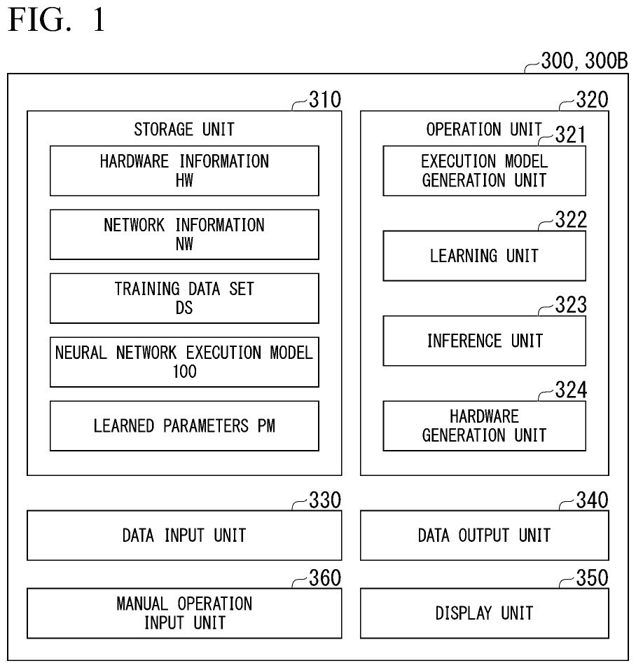

A first embodiment of the present invention will be explained with reference to FIG. 1 to FIG. 25.

FIG. 1 is a diagram illustrating a neural network generating device 300 according to the present embodiment.

### [Neural Network Generating Device 300]

The neural network generating device 300 is a device that generates a trained neural network execution model 100 that is embeddable in an embedded device such as an IoT device. The neural network execution model 100 is a software or hardware model generated for operating a convolutional neural network 200 (hereinafter referred to as “CNN 200”) in an embedded device.

The neural network generating device 300 is a program-executable device (computer) provided with a processor such as a CPU (Central Processing Unit) and hardware such as a memory. The functions of the neural network generating device 300 are realized by executing a neural network generating program in the neural network generating device 300. The neural network generating device 300 is provided with a storage unit 310, an operation unit 320, a data input unit 330, a data output unit 340, a display unit 350, and a manual operation input unit 360.

The storage unit 310 stores hardware information HW, network information NW, a training data set DS, a neural network execution model 100 (hereinafter referred to as an “NN execution model 100”), and learned parameters PM. The hardware information HW, the training data set DS, and the network information NW are input data that are input to the neural network generating device 300. The NN execution model 100 and the learned parameters PM are output data output by the neural network generating device 300. A “trained NN execution model 100” includes an NN execution model 100 and learned parameters PM.

The hardware information HW is information regarding an embedded device in which the NN execution model 100 is being run (hereinafter referred to as “operated hardware”). The hardware information HW is, for example, the device type of the operated hardware, a device constraint, a memory configuration, a bus configuration, an operating frequency, power consumption, a manufacturing process type, or the like. The device type is, for example, a type such as an ASIC (Application-Specific Integrated Circuit) or an FPGA (Field-Programmable Gate Array). The device constraint is the upper limit of the number of processors included in the operated device, the upper limit of the circuit size, or the like. The memory configuration is the memory type, the number of memory units, the memory capacity, or the input/output data width. The bus configuration is the bus type, the bus width, the bus communication standard, connected devices on the same bus, or the like. Additionally, in the case in which there are multiple variations of the NN execution model 100, the hardware information HW includes information regarding the variations of the NN execution model 100.

The network information NW is basic information regarding the CNN 200. The network information NW is, for example, the network configuration of the CNN 200, input data information, output data information, quantization information, or the like. The input data information is the input data type such as images or audio, the input data size, or the like.

The training data set DS includes training data D1 used for training and test data D2 used for inference tests.

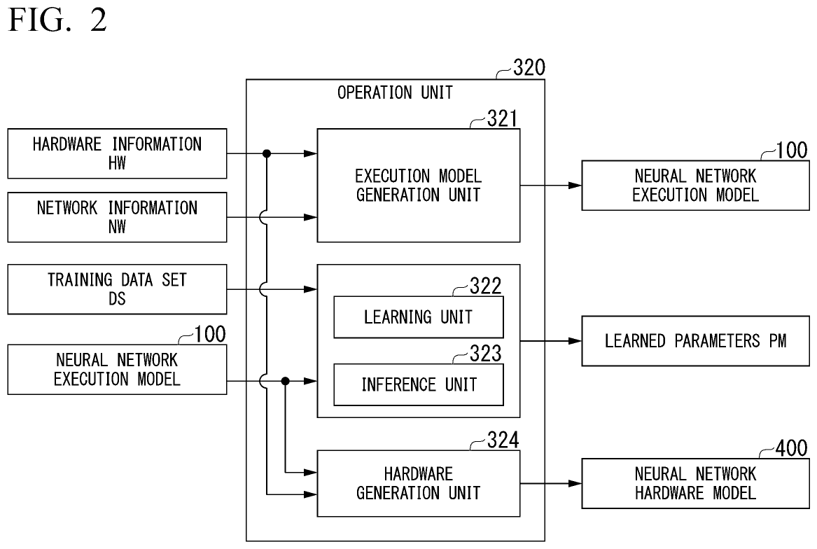

FIG. 2 is a diagram illustrating input to and output from the operation unit 320.

The operation unit 320 has an execution model generation unit 321, a learning unit 322, an inference unit 323, and a hardware generation unit 324. The NN execution model 100 input to the operation unit 320 may be generated by a device other than the neural network generating device 300.

The execution model generation unit 321 generates an NN execution model 100 based on the hardware information HW and the network information NW.

The learning unit 322 uses the NN execution model 100 and the training data D1 to generate learned parameters PM. The inference unit 323 uses the NN execution model 100 and test data D2 to implement an inference test.

The hardware generation unit 324 generates a neural network hardware model 400 based on the hardware information HW and the NN execution model 100. The neural network hardware model 400 is a hardware model that can be installed in the operated hardware. The neural network hardware model 400 is optimized for the operated hardware based on the hardware information HW. The neural network hardware model 400 may be an RTL (Register Transfer Level), may be a net list indicating connections between gates and circuit modules, or may be a combination thereof. The neural network hardware model 400 may be a parameter list or a configuration file necessary for installing the NN execution model 100 on the hardware. The parameter list or the configuration file is used in combination with the separately generated NN execution model 100.

Hardware information HW, network information NW, and the like necessary for generating the trained NN execution model 100 are input to the data input unit 330. The hardware information HW, the network information NW, and the like are input, for example, as data written in a prescribed data format. The hardware information HW, the network information NW, and the like that have been input are stored in the storage unit 310. The hardware information HW, the network information NW, and the like may be input or changed by the user using the manual operation input unit 360.

A trained NN execution model 100 that has been generated is output to the data output unit 340. For example, the generated NN execution model 100 and learned parameters PM are output to the data output unit 340.

The display unit 350 has a known type of monitor such as an LCD display. The display unit 350 can display a console screen or the like for receiving GUI (Graphical User Interface) images, commands, or the like generated by the operation unit 320. Additionally, in the case in which the operation unit 320 requires information to be input by the user, the display unit 350 can display a message prompting the user to input information using the manual operation input unit 360, or a GUI image required for inputting information.

The manual operation input unit 360 is a device for the user to input instructions to the operation unit 320 or the like. The manual operation input unit 360 is a known type of input device such as a touch panel, a keyboard, or a mouse. The inputs to the manual operation input unit 360 are transmitted to the operation unit 320.

Some or all of the functions of the operation unit 320 are realized, for example, by one or more processors like a CPU (Central Processing Unit) or a GPU (Graphics Processing Unit) executing a program stored in a program memory. However, some or all of the functions of the operation unit 320 may be realized by hardware (e.g., circuitry) such as an LSI (Large-Scale Integrated circuit), an ASIC (Application-Specific Integrated Circuit), an FPGA (Field-Programmable Gate Array), or a PLD (Programmable Logic Device). Additionally, some or all of the functions of the operation unit 320 may be realized by combining software with hardware.

Some or all of the functions of the operation unit 320 may be realized by using a CPU or a GPU provided in an external device such as a cloud server, or an external accelerator such as hardware. The operation speed of the operation unit 320 can be improved, for example, by using the operation unit 320 in conjunction with dedicated hardware or a GPU having high operation performance on a cloud server.

The storage unit 310 is realized by means of flash memory, an EEPROM (Electrically Erasable Programmable Read-Only Memory), a ROM (Read-Only Memory), a RAM (Random Access Memory), or the like. All or some of the storage unit 310 may be provided in an external device such as a cloud server, and may be connected to the operation unit 320 or the like by a communication line.

### [Convolutional Neural Network (CNN) 200]

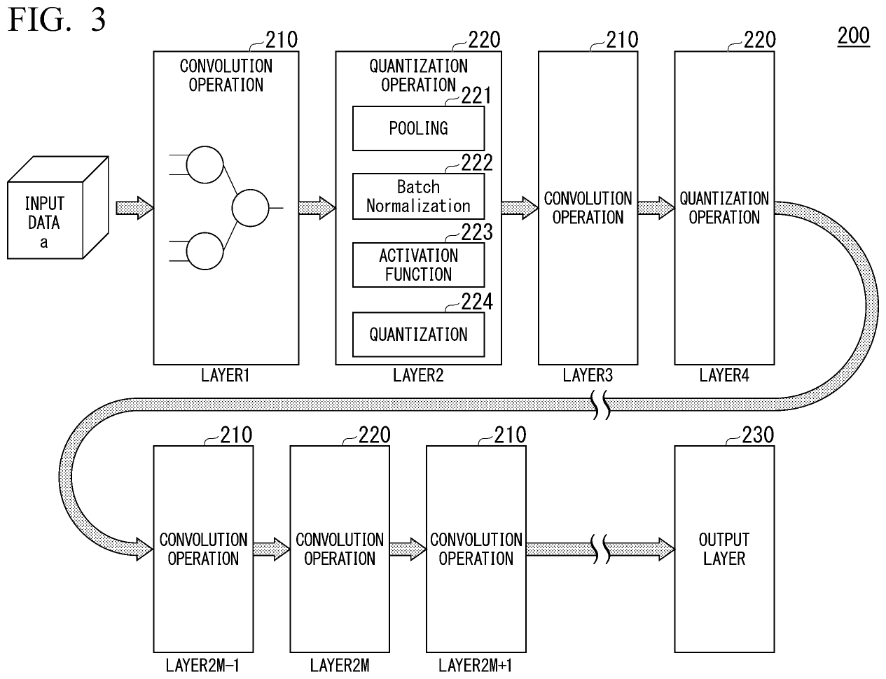

Next, the CNN 200 will be explained. FIG. 3 is a diagram illustrating an example of a CNN 200. The network information NW in the CNN 200 is information regarding the configuration of the CNN 200 explained below. The CNN 200 uses low-bit weights w and quantized input data a, and can easily be embedded in an embedded device.

The CNN 200 is a network having a multilayered structure, including convolution layers 210 that perform convolution operations, quantization operation layers 220 that perform quantization operations, and an output layer 230. In at least part of the CNN 200, the convolution layers 210 and the quantization operation layers 200 are connected in an alternating manner. The CNN 200 is a model that is widely used for image recognition and video recognition. The CNN 200 may further have a layer with another function, such as a fully connected layer.

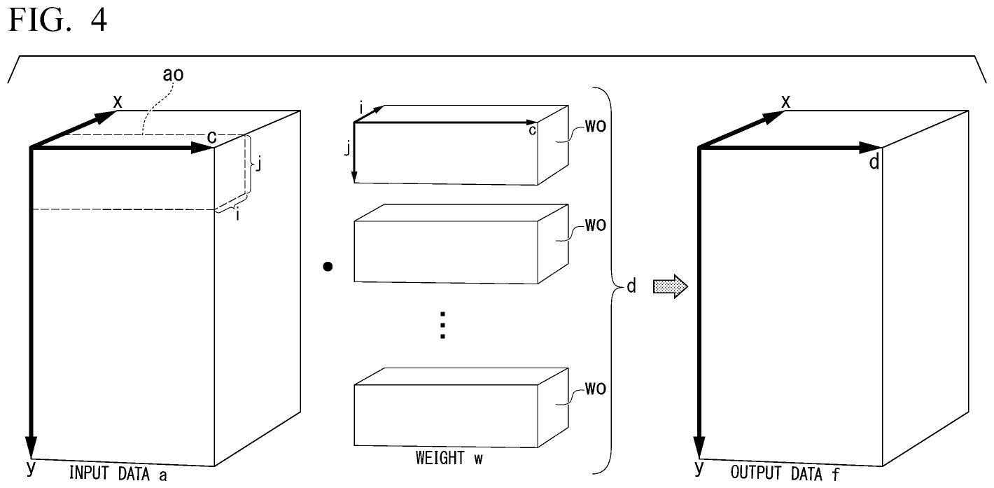

FIG. 4 is a diagram explaining the convolution operations performed by the convolution layers 210.

The convolution layers 210 perform convolution operations in which weights w are used on input data a. When the input data a and the weights w are input, the convolution layers 210 perform multiply-add operations.

The input data a (also referred to as activation data or a feature map) that is input to the convolution layers 210 is multi-dimensional data such as image data. In the present embodiment, the input data a is a three-dimensional tensor comprising elements (x, y, c). The convolution layers 210 in the CNN 200 perform convolution operations on the low-bit input data a. In the present embodiment, the elements of the input data a are 2-bit unsigned integers (0, 1, 2, 3). The elements of the input data a may, for example, be 4-bit or 8-bit unsigned integers.

If the input data that is to be input to the CNN 200 is in a format, e.g., of the 32-bit floating-point type, different from that of the input data a input to the convolution layers 210, then the CNN 200 may further have an input layer for performing type conversion or quantization in front of the convolution layers 210.

The weights w (also referred to as filters or kernels) in the convolution layers 210 are multi-dimensional data having elements that are learnable parameters. In the present embodiment, the weights w are four-dimensional tensors comprising the elements (i, j, c, d). The weights w include d three-dimensional tensors (hereinafter referred to as “weights wo”) having the elements (i, j, c). The weights w in a trained CNN 200 are learned data. The convolution layers 210 in the CNN 200 use low-bit weights w to perform convolution operations. In the present embodiment, the elements of the weights w are 1-bit signed integers (0, 1), where the value “0” represents +1 and the value “1” represents −1.

The convolution layers 210 perform the convolution operation indicated in Equation 1 and output the output data f. In Equation 1, s indicates a stride. The region indicated by the dotted line in FIG. 4 indicates one region ao (hereinafter referred to as “application region ao”) in which the weights wo are applied to the input data a. The elements of the application region ao can be represented by (x+i, y+j, c).

f(x,y,d)=Σᵢ^{K}Σᵢ^{K}Σ_{c}^{C}a(s·x+i,s·y+j,c)·w(i,j,c,d) [Equation 1]

The quantization operation layers 220 implement quantization or the like on the convolution operation outputs that are output by the convolution layers 210. The quantization operation layers 220 each have a pooling layer 221, a batch normalization layer 222, an activation function layer 223, and a quantization layer 224.

The pooling layer 221 implements operations such as average pooling (Equation 2) and max pooling (Equation 3) on the convolution operation output data f output by a convolution layer 210, thereby compressing the output data f from the convolution layer 210. In Equation 2 and Equation 3, u indicates an input tensor, v indicates an output tensor, and T indicates the size of a pooling region. In Equation 3, max is a function that outputs the maximum value of u for combinations of i and j contained in T.

$$v ( x , y , c ) = \frac{1}{{T}^{2}} {\sum }_{i}^{T} {\sum }_{j}^{T} u ( T \cdot x + i , T \cdot y + j , c ) \qquad [ Equation 2 ]$$

v(x,y,c)=max(u(T·x+i,T·y+j,c)),i∈T,j∈T [Equation 3]

The batch normalization layer 222 normalizes the data distribution of the output data from a quantization operation layer 220 or a pooling layer 221 by means of an operation as indicated, for example, by Equation 4. In Equation 4, u indicates an input tensor, v indicates on output tensor, a indicates a scale, and β indicates a bias. In a trained CNN 200, α and β are learned constant vectors.

v(x,y,c)=α(c)·(u(x,y,c)−β(c)) [Equation 4]

The activation function layer 223 performs activation function operations such as ReLU (Equation 5) on the output from a quantization operation layer 220, a pooling layer 221, or a batch normalization layer 222. In Equation 5, u is an input tensor and v is an output tensor. In Equation 5, max is a function that outputs the argument having the highest numerical value.

v(x,y,c)=max(0,u(x,y,c)) [Equation 5]

The quantization layer 224 performs quantization as indicated, for example, by Equation 6, on the outputs from a pooling layer 221 or an activation function layer 223, based on quantization parameters. The quantization indicated by Equation 6 reduces the bits in an input tensor u to 2 bits. In Equation 6, q(c) is a quantization parameter vector. In a trained CNN 200, q(c) is a learned constant vector. In Equation 6, the inequality signs “≤” may be replaced with “<”.

$$\begin{matrix}qtz ( x , y , c ) = 0 if u ( x , y , c ) ≦ q ( c ) \cdot th 0 else \\ 1 if u ( x , y , c ) ≦ q ( c ) \cdot th 1 else \\ 2 if u ( x , y , c ) ≦ q ( c ) \cdot th 2 else \\ 3\end{matrix} \qquad [ Equation 6 ]$$

The output layer 230 is a layer that outputs the results of the CNN 200 by means of an identity function, a softmax function or the like. The layer preceding the output layer 230 may be either a convolution layer 210 or a quantization operation layer 220.

In the CNN 200, quantized output data from the quantization layers 224 are input to the convolution layers 210. Thus, the load of the convolution operations in the convolution layers 210 is smaller than that in other convolutional neural networks in which quantization is not performed.

### [Neural Network Execution Model 100 (NN Execution Model) 100]

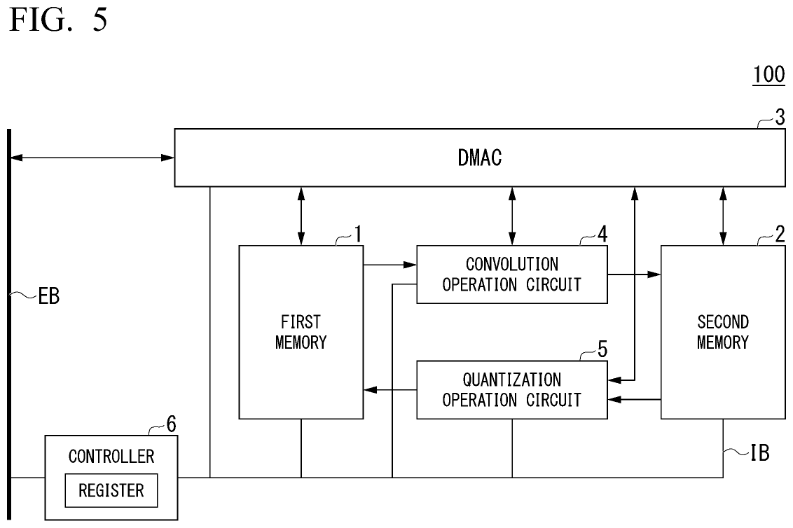

Next, the NN execution model 100 will be explained. FIG. 5 is a diagram illustrating an example of an NN execution model 100. The NN execution model 100 is a software or hardware model generated for making the CNN 200 operate in the operated hardware. Software includes software for controlling a hardware model. The hardware model may be at the behavior level or may be at the RTL (Register Transfer Level), may be a net list indicating connections between gates and circuit modules, or may be a combination thereof.

The NN execution model 100 is provided with a first memory 1, a second memory 2, a DMA controller 3 (hereinafter also referred to as “DMAC 3”), a convolution operation circuit 4, a quantization operation circuit 5, and a controller 6. The NN execution model 100 is characterized in that the convolution operation circuit 4 and the quantization operation circuit 5 form a loop with the first memory 1 and the second memory 2 therebetween.

The first memory 1 is a rewritable memory such as a volatile memory composed, for example, of SRAM (Static RAM) or the like. Data is written into and read from the first memory 1 via the DMAC 3 and the controller 6. The first memory 1 is connected to an input port of the convolution operation circuit 4, and the convolution operation circuit 4 can read data from the first memory 1. Additionally, the first memory 1 is connected to an output port of the quantization operation circuit 5, and the quantization operation circuit 5 can write data into the first memory 1. An external host CPU can input and output data with respect to the NN execution model 100 by writing and reading data with respect to the first memory 1.

The second memory 2 is a rewritable memory such as a volatile memory composed, for example, of SRAM (Static RAM) or the like. Data is written into and read from the second memory 2 via the DMAC 3 and the controller 6. The second memory 2 is connected to an input port of the quantization operation circuit 5, and the quantization operation circuit 5 can read data from the second memory 2. Additionally, the second memory 2 is connected to an output port of the convolution operation circuit 4, and the convolution operation circuit 4 can write data into the second memory 2. An external host CPU can input and output data with respect to the NN execution model 100 by writing and reading data with respect to the second memory 2.

The DMAC 3 is connected to an external bus EB and transfers data between an external memory, such as a DRAM, and the first memory 1. Additionally, the DMAC 3 transfers data between an external memory, such as a DRAM, and the second memory 2. Additionally, the DMAC 3 transfers data between an external memory, such as a DRAM, and the convolution operation circuit 4. Additionally, the DMAC 3 transfers data between an external memory, such as a DRAM, and the quantization operation circuit 5.

The convolution operation circuit 4 is a circuit that performs a convolution operation in a convolution layer 210 in the trained CNN 200. The convolution operation circuit 4 reads input data a stored in the first memory 1 and implements a convolution operation on the input data a. The convolution operation circuit 4 writes output data f (hereinafter also referred to as “convolution operation output data”) from the convolution operation into the second memory 2.

The quantization operation circuit 5 is a circuit that performs at least part of a quantization operation in a quantization operation layer 220 in the trained CNN 200. The quantization operation circuit 5 reads the output data f from the convolution operation stored in the second memory 2, and performs a quantization operation (among pooling, batch normalization, an activation function, and quantization, the operation including at least quantization) on the output data f from the convolution operation. The quantization operation circuit 5 writes the output data (hereinafter referred to as “quantization operation output data”) from the quantization operation into the first memory 1.

The controller 6 is connected to the external bus EB and operates as a slave to an external host CPU. The controller 6 has a register 61 including a parameter register and a state register. The parameter register is a register for controlling the operation of the NN execution model 100. The state register is a register indicating the state of the NN execution model 100 and including semaphores S. The external host CPU can access the register 61 via the controller 6.

The controller 6 is connected, via an internal bus IB, to the first memory 1, the second memory 2, the DMAC 3, the convolution operation circuit 4, and the quantization operation circuit 5. The external host CPU can access each block via the controller 6. For example, the external host CPU can issue commands to the DMAC 3, the convolution operation circuit 4, and the quantization operation circuit 5 via the controller 6. Additionally, the DMAC 3, the convolution operation circuit 4, and the quantization operation circuit 5 can update the state register (including the semaphores S) in the controller 6 via the internal bus IB. The state register (including the semaphores S) may be configured to be updated via dedicated lines connected to the DMAC 3, the convolution operation circuit 4, or the quantization operation circuit 5.

Since the NN execution model 100 has a first memory 1, a second memory 2, and the like, the number of data transfers of redundant data can be reduced in data transfer by the DMAC 3 from external memory such as a DRAM. As a result thereof, the power consumption due to memory access can be largely reduced.

### [Operations of Neural Network Generating Device 300]

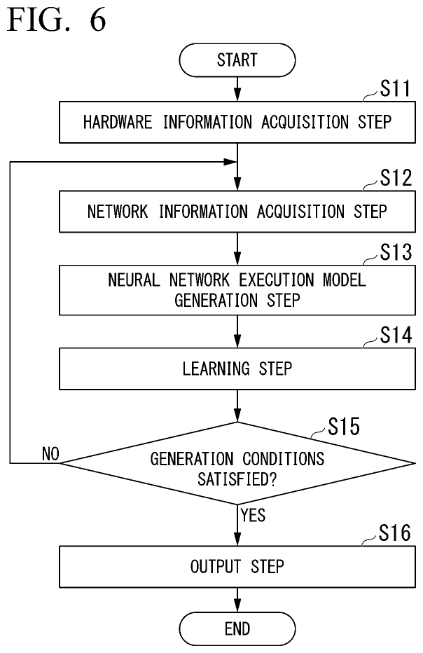

Next, the operations (neural network generating method) of the neural network generating device 300 will be explained by following the control flow chart for the neural network generating device 300 indicated in FIG. 6. The neural network generating device 300 implements an initialization process (step S10), then executes step S11.

### <Hardware Information Acquisition Step (S11)>

In step S11, the neural network generating device 300 acquires hardware information HW for the operated hardware (hardware information acquisition step). The neural network generating device 300, for example, acquires hardware information HW input to the data input unit 330. The neural network generating device 300 may display a GUI image necessary for inputting the hardware information HW on the display unit 350, and may acquire the hardware information HW by having a user input the hardware information HW by using the manual operation input unit 360.

The hardware information HW specifically includes a memory type, a memory capacity, and an input/output data width for memory allocated to the first memory 1 and the second memory 2.

The acquired hardware information HW is stored in the storage unit 310. Next, the neural network generating device 300 executes step S12.

### <Network Information Acquisition Step (S12)>

In step S12, the neural network generating device 300 acquires network information NW for the CNN 200 (network information acquisition step). The neural network generating device 300 acquires, for example, network information NW input to the data input unit 330. The neural network generating device 300 may display a GUI image necessary for inputting the network information NW on the display unit 350, and may acquire the network information NW by having a user input the network information NW by using the manual operation input unit 360.

The network information NW specifically includes the network configuration including the input layer and the output layer 230, the configuration of the convolution layers 210 including the bit widths of weights w and input data a, and the configuration of the quantization operation layers 220 including quantization information.

The acquired network information NW is stored in the storage unit 310. Next, the neural network generating device 300 executes step S13.

### <Neural Network Execution Model Generation Step (S13)>

In step S13, the execution model generation unit 321 in the neural network generating device 300 generates an NN execution model 100 based on the hardware information HW and the network information NW (neural network execution model generation step).

The neural network execution model generation step (NN execution model generation step) involves, for example, a layer mapping step (S13-1), a convolution operation circuit generation step (S13-2), a quantization operation circuit generation step (S13-3), and a DMAC generation step (S13-4).

### <Layer Mapping Step (S13-1)>

The execution model generation unit 321 maps the respective layers of the CNN 200 onto a convolution operation circuit 4 and a quantization operation circuit 5 that are formed into a loop (layer mapping step). The execution model generation unit 321 generates sequence data and software for sequentially executing the respective layers of the CNN 200 in the NN execution model 100. For layers including operations that cannot be implemented by the NN execution model 100, such as the input layer and the output layer 230, a software module executable by an external operation device, such as an external host CPU, other than the NN execution model 100, is generated.

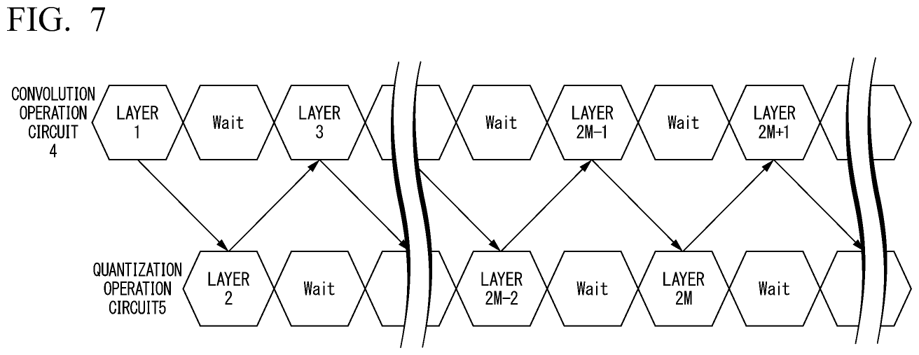

FIG. 7 is a timing chart indicating an operating example of the NN execution model 100. The execution model generation unit 321, for example, generates sequence data or software that can implement the operations of the NN execution model 100 indicated in FIG. 7. Hereinafter, the operating example of the NN execution model 100 indicated in FIG. 7 will be explained.

The DMAC 3 stores the input data a input to layer-1 (see FIG. 3) in the first memory 1. The DMAC 3 may transfer the input data a input to layer-1 after partitioning the data in accordance with the order of convolution operations performed by the convolution operation circuit 4.

The convolution operation circuit 4 reads out the input data a input to layer-1 (see FIG. 3) stored in the first memory 1. The convolution operation circuit 4 performs a layer-1 convolution operation on the input data a input to layer-1. The output data f from the layer-1 convolution operation is stored in the second memory 2.

The quantization operation circuit 5 reads the output data f from layer-1 stored in the second memory 2. The quantization operation circuit 5 performs a layer-2 quantization operation on the output data f from layer-1. The output data from the layer-2 quantization operation is stored in the first memory 1.

The convolution operation circuit 4 reads the output data from the layer-2 quantization operation stored in the first memory 1. The convolution operation circuit 4 performs a layer-3 convolution operation using the output data from the layer-2 quantization operation as the input data a. The output data f of the layer-3 convolution operation is stored in the second memory 2.

The convolution operation circuit 4 reads the output data from a layer-(2M−2) (M being a natural number) quantization operation stored in the first memory 1. The convolution operation circuit 4 performs a layer-(2M−1) convolution operation using the output data from the layer-(2M−2) quantization operation as the input data a. The output data f of the layer-(2M−1) convolution operation is stored in the second memory 2.

The quantization operation circuit 5 reads the output data f from layer-(2M−1) stored in the second memory 2. The quantization operation circuit 5 performs a layer-2M quantization operation on the output data f from layer-(2M−1). The output data of the layer-2M quantization operation is stored in the first memory 1.

The convolution operation circuit 4 reads the output data from the layer-2M quantization operation stored in the first memory 1. The convolution operation circuit 4 performs a layer-(2M+1) convolution operation using the output data from the layer-2M quantization operation as the input data a. The output data f of the layer-(2M+1) convolution operation is stored in the second memory 2.

The convolution operation circuit 4 and the quantization operation circuit 5 perform operations in an alternating manner to carry out the operations of the CNN 200 indicated in FIG. 3. In the NN execution model 100, the convolution operation circuit 4 implements the layer-(2M−1) and layer-(2M+1) convolution operations in a time-divided manner. Additionally, in the NN execution model 100, the quantization operation circuit 5 implements the layer-(2M−2) and layer-2M quantization operations in a time-divided manner. For this reason, the NN execution model 100 has an extremely small circuit size in comparison with the case in which separate convolution operation circuits 4 and quantization operation circuits 5 are provided for each layer.

The NN execution model 100 carries out operations of the CNN 200, which has a multi-layered structure with multiple layers, by means of a circuit formed in the shape of a loop. The NN execution model 100 can make efficient use of hardware resources by means of the loop-shaped circuit configuration. In the NN execution model 100, the parameters in the convolution operation circuit 4 and the quantization operation circuit 5, which change in each layer, are appropriately updated in order to form a loop-shaped circuit.

In the case in which an operation that cannot be implemented by the NN execution model 100 is included among the operations of the CNN 200, the NN execution model 100 transfers intermediate data to an external operation device such as an external host CPU. After the external operation device has performed operations on the intermediate data, operation results by the external operation device are input to the first memory 1 or the second memory 2. The NN execution model 100 resumes operations on the operation results by the external operation device.

### <Convolution Operation Circuit Generation Step (S13-2)>

The execution model generation unit 321 generates the convolution operation circuit 4 of the NN execution model 100 based on hardware information HW and network information NW (convolution operation circuit generation step). The execution model generation unit 321 partitions the data from the convolution operations in the convolution layers 210 based on the memory capacities of memory allocated to the first memory 1 and the second memory 2. The convolution operation circuit 4 that is generated has a configuration capable of performing operations on the partitioned convolution operation data. If the size (Bc or Bd) of blocks into which the convolution operation data of the convolution layers 210 are partitioned is made small, then the hardware size of the convolution operation circuit 4 becomes small. However, the operation efficiency of convolution operations of the convolution layers 210 becomes lower.

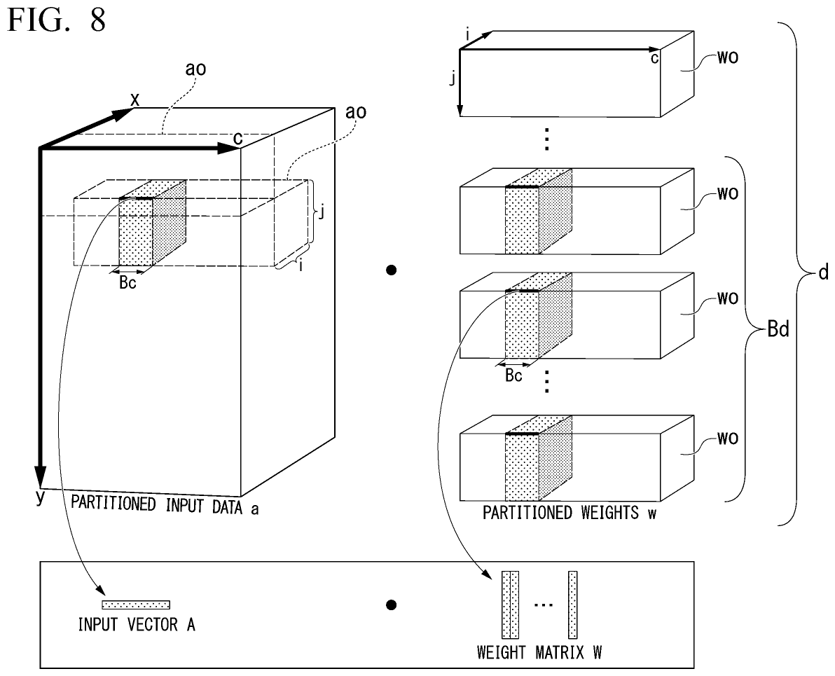

FIG. 8 is a diagram for explaining data partitioning and data expansion in the convolution operation.

The convolution operation circuit 4 in the NN execution model 100 performs operations by partitioning the input data input to the convolution operations (Equation 1) in the convolution layers 210 into partial tensors. The partitioning method and the number of partitions of the partial tensors are not particularly limited. The partial tensors are formed, for example, by partitioning the input data a(x+i, y+j, c) into a(x+i, y+j, co). The convolution operation circuit 4 in the NN execution model 100 can also perform operations on the input data to the convolution operations (Equation 1) in the convolution layers 210 without partitioning the input data.

### <Convolution Operation Circuit Generation Step: Data Partitioning in Convolution Operations>

When the input data input to a convolution operation is partitioned, the variable c in Equation 1 is partitioned into blocks of size Bc, as indicated by Equation 7. Additionally, the variable d in Equation 1 is partitioned into blocks of size Bd, as indicated by Equation 8. In Equation 7, co is an offset, and ci is an index from 0 to (Bc−1). In Equation 8, do is an offset, and di is an index from 0 to (Bd−1). The size Bc and the size Bd may be the same.

c=co·Bc+ci [Equation 7]

d=do·Bd+di [Equation 8]

The input data a(x+i, y+j, c) in Equation 1 is partitioned into the size Bc in the c-axis direction and is expressed as the partitioned input data a(x+i, y+j, co). In the explanation below, input data a that has been partitioned is also referred to as “partitioned input data a”.

The weight w(i, j, c, d) in Equation 1 is partitioned into the size Bc in the c-axis direction and into the size Bd in the d-axis direction, and is expressed as the partitioned weight w (i, j, co, do). In the explanation below, a weight w that has been partitioned will also referred to as a “partitioned weight w”.

The output data f(x, y, do) partitioned into the size Bd is determined by Equation 9. The final output data f(x, y, d) can be computed by combining the partitioned output data f(x, y, do).

f(x,y,do)=Σᵢ^{K}Σⱼ^{K}Σ_{co}^{C/Bc}a(s·x+i,s·y+j,co)·w(i,j,co,do) [Equation 9]

### <Convolution Operation Circuit Generation Step (S13-2): Data Expansion>

The convolution operation circuit 4 in the NN execution model 100 performs convolution operations by expanding the input data a and the weights w in the convolution operations by the convolution layers 210.

The partitioned input data a(x+i, y+j, co) is expanded into vector data having Bc elements. The elements in the partitioned input data a are indexed by ci (where 0≤ci<Bc). In the explanation below, partitioned input data a expanded into vector data for each of i and j will also be referred to as “input vector A”. An input vector A has elements from partitioned input data a(x+i, y+j, co×Bc) to partitioned input data a(x+i, y+j, co×Bc+(Bc−1)).

The partitioned weights w(i, j, co, do) are expanded into matrix data having Bc×Bd elements. The elements of the partitioned weights w expanded into matrix data are indexed by ci and di (where 0≤di<Bd). In the explanation below, a partitioned weight w expanded into matrix data for each of i and j will also be referred to as a “weight matrix W”. A weight matrix W has elements from a partitioned weight w(i, j, co×Bc, do×Bd) to a partitioned weight w(i, j, co×Bc+(Bc−1), do×Bd+(Bd−1)).

Vector data is computed by multiplying an input vector A with a weight matrix W. Output data f(x, y, do) can be obtained by formatting vector data computed for each of i, j, and co as a three-dimensional tensor. By expanding data in this manner, the convolution operations in the convolution layers 210 can be implemented by multiplying vector data with matrix data.

The sizes (Bc and Bd) of the blocks into which the convolution operation data is partitioned are set, for example, to sizes such that a prescribed number of partitioned input data a and a prescribed number of partition weights w can be stored in the first memory 1.

For example, suppose that the size of the input data a is X×Y×C, the size of the weights w is K×K×C×D, and the size of the output data f is X×Y x D. The output data f(x, y, do) partitioned into the size Bd in the d-axis direction can be computed by performing convolution operations, for each value of i, j, and co, on the input data a(x+i, y+j, co) partitioned into the size Bc in the c-axis direction and the weights w(i, j, co, do) partitioned into the sizes Bc and Bd, and summing the results thereof.

If the elements of the output data f are 16 bits long, then the size of the output data f(x, y, do) partitioned into the size Bd in the d-axis direction is 16·X·Y·Bd bits. Meanwhile, if the elements of the input data a are 2 bits long, then the size of the input data a necessary for computing the output data f partitioned into the size Bd is 2·X·Y·Bc bits. Additionally, if the elements of the weights w are 1 bit long, then the size of the weights w necessary for computing the output data f partitioned into the size Bd is 1·K·K·Bc·Bd bits.

If the memory capacity of the second memory 2 is larger than 16·X·Y·Bd bits, then the output data f(x, y, do) partitioned into the size Bd can be stored in the second memory 2. Meanwhile, if the memory capacity of the first memory 1 is larger than (2·X·Y·Bc+1·K·K·Bc·Bd) bits, then the input data a and the weights w necessary for computing the output data f partitioned into the size Bd can be stored in the first memory 1.

Based on the relationship mentioned above, if designated as a constraint in the hardware information HW, the upper limits of the memory capacities of the first memory 1 and the second memory 2 can be used to compute the sizes (Bc or Bd) of partitioned blocks. Additionally, the memory capacities of the first memory 1 and the second memory 2 can be computed from the sizes (Bc or Bd) of partitioned blocks.

In order to make parallel operation, for example, of the convolution operation circuit 4 and the DMAC 3 possible, the first memory 1 and the second memory 2 should preferably have memory capacities that are at least twice the memory capacities mentioned above, and should be able to implement double buffering.

The above example is an example of a means for determining the sizes (Bc and Bd) of partitioned blocks or the memory capacities of the first memory 1 and the second memory 2. The determinations of the sizes (Bc and Bd) of partitioned blocks or the memory capacities of the first memory 1 and the second memory 2 are appropriately changed in accordance with the mode of memory use, the number of parallel operations, and the like.

<Convolution Operation Circuit Generation Step (S13-2): Partitioning into Partial Tensors (1)>

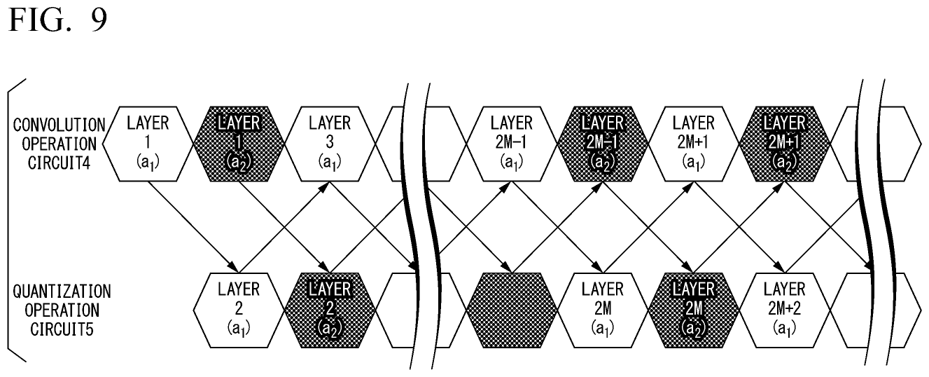

FIG. 9 is a timing chart indicating another operating example of the NN execution model 100.

The NN execution model 100 may partition the input data a into partial tensors and may perform operations on the partial tensors in a time-divided manner.

FIG. 9 shows an operating example for the case in which the input data a is decomposed into two partial tensors. The decomposed partial tensors are referred to as “first partial tensor a₁” and “second partial tensor a₂”. For example, the layer-(2M−1) convolution operation is decomposed into a convolution operation corresponding to the first partial tensor a₁ (in FIG. 9, indicated by “Layer 2M−1 (a₁)”) and a convolution operation corresponding to the second partial tensor a₂ (in FIG. 9, indicated by “Layer 2M−1 (a₂)”).

The convolution operations and the quantization operations corresponding to the first partial tensor a₁ can be implemented independent of the convolution operations and the quantization operations corresponding to the second partial tensor a₂, as illustrated in FIG. 9.

The convolution operation circuit 4 performs a layer-(2M−1) convolution operation corresponding to the first partial tensor a₁ (in FIG. 9, the operation indicated by “Layer 2M−1 (a₁)”). Thereafter, the convolution operation circuit 4 performs a layer-(2M−1) convolution operation corresponding to the second partial tensor a₂ (in FIG. 9, the operation indicated by “Layer 2M−1 (a₂)”). Additionally, the quantization operation circuit 5 performs a layer-2M quantization operation corresponding to the first partial tensor a₁ (in FIG. 9, the operation indicated by “Layer 2M (a₁)”). Thus, the NN execution model 100 can implement the layer-(2M−1) convolution operation corresponding to the second partial tensor a₂ and the layer-2M quantization operation corresponding to the first partial tensor a₁ in parallel.

Next, the convolution operation circuit 4 performs a layer-(2M+1) convolution operation corresponding to the first partial tensor a₁ (in FIG. 9, the operation indicated by “Layer 2M+1 (a₁)”). Additionally, the quantization operation circuit 5 performs a layer-2M quantization operation corresponding to the second partial tensor a₂ (in FIG. 9, the operation indicated by “Layer 2M (a₂)”). Thus, the NN execution model 100 can implement the layer-(2M+1) convolution operation corresponding to the first partial tensor a₁ and the layer-2M quantization operation corresponding to the second partial tensor a₂ in parallel.

By partitioning the input data a into partial tensors, the NN execution model 100 can make the convolution operation circuit 4 and the quantization operation circuit 5 operate in parallel. As a result thereof, the time during which the convolution operation circuit 4 and the quantization operation circuit 5 are idle can be reduced, thereby increasing the operation processing efficiency of the NN execution model 100. Although the number of partitions in the operating example indicated in FIG. 9 was two, the NN execution model 100 can similarly make the convolution operation circuit 4 and the quantization operation circuit 5 operate in parallel even in cases in which the number of partitions is greater than two.

<Convolution Operation Circuit Generation Step (S13-2): Partitioning into Partial Tensors (2)>

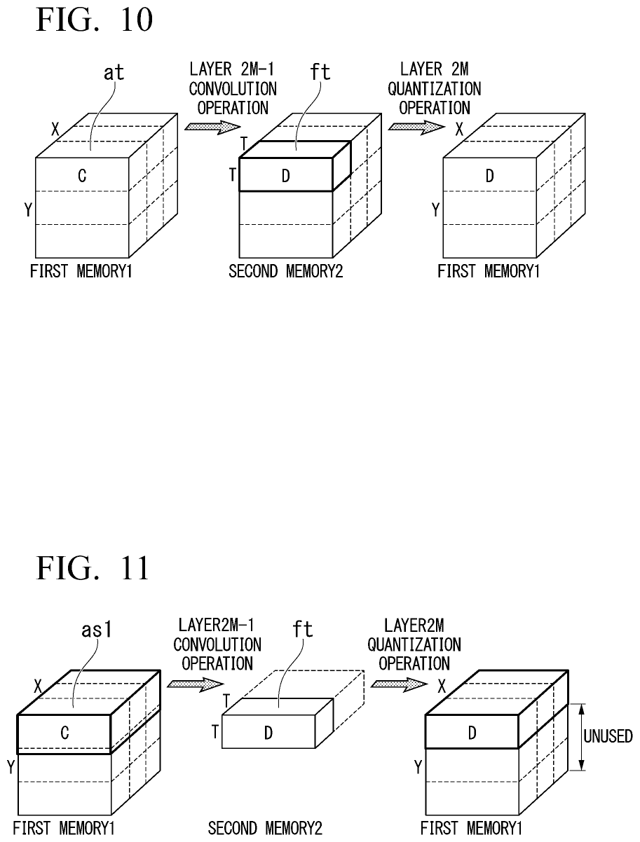

FIG. 10 is a diagram illustrating a partial tensor ft obtained by tile-partitioning output data f from a convolution operation. The input data at is partitioned into tiles (blocks) of prescribed sizes in the x-axis direction and the y-axis direction. The partial tensor ft is partitioned into tiles (blocks) of size Tin each of the x-axis direction and the y-axis direction. As in the abovementioned example, the size of the input data a is X×Y×C, the size of the weights w is K×K×C×D, and the size of the output data f is X×Y×D. The size of the partial tensor ft is T·T·D.

The convolution operation circuit 4 reads a portion of the input data at from the first memory 1 and performs a layer-(2M−1) convolution operation that outputs the partial tensor ft (referred to as the first partial tensor ft₁). The first partial tensor ft₁ is written into the second memory 2. Before implementing a convolution operation with respect to the remainder of the input data a stored in the first memory 1, the quantization operation circuit 5 performs a layer-2M quantization operation corresponding to the first partial tensor ft₁ stored in the second memory 2. The output data from the layer-2M quantization operation is written into the first memory 1. As a result thereof, the first partial tensor ft₁ written into the second memory 2 becomes unnecessary.

Next, the convolution operation circuit 4 reads another portion of the input data at from the first memory 1 and performs a layer-(2M−1) convolution operation that outputs a partial tensor ft (referred to as the second partial tensor ft₂). The second partial tensor ft₂ is written into the second memory 2. The second partial tensor ft₂ is written over the first partial tensor ft₁. Before implementing a convolution operation with respect to the remainder of the input data a stored in the first memory 1, the quantization operation circuit 5 performs a layer-2M quantization operation corresponding to the second partial tensor ft₂ stored in the second memory 2. The output data from the layer-2M quantization operation is written into the first memory 1. As a result thereof, the second partial tensor ft₂ written into the second memory 2 becomes unnecessary.

By performing the above-mentioned operations on the remainder of the input data a from the first memory 1, the layer-(2M−1) convolution operation and the layer-2M convolution operation are completed. By tile-partitioning the output data f from the convolution operations in this way, the size of the second memory 2 can be reduced to a memory size capable of storing a single partial tensor ft. For example, suppose that the output data f is 16 bits long. If tile partitioning is not performed, then the second memory 2 must store the output data f, and the necessary memory size is 16·X·Y·D bits. However, if tile partitioning is performed, then it is sufficient for the second memory 2 to be capable of storing a single partial tensor ft, and the necessary memory size can be reduced to 16·T²·D bits.

On the other hand, in the case in which tile partitioning is used, the input data a to the layer-(2M−1) convolution operation and the output data from the layer-2M quantization operation must be held separately in the first memory 1. However, by making the size of T much smaller than X and Y, the overall memory capacity of the first memory 1 and the second memory 2 can be reduced.

<Convolution Operation Circuit Generation Step (S13-2): Partitioning into Partial Tensors (3)>

FIG. 11 to FIG. 13 are diagrams illustrating partial tensors as obtained by slice-partitioning input data. The partial tensors as are obtained by partitioning the input data a into slices (blocks) of a prescribed size in the y-axis direction.

As illustrated in FIG. 11, the convolution operation circuit 4 reads a portion of the partial tensor as (first partial tensor as₁) from the first memory 1 and performs a layer-(2M−1) convolution operation that outputs the partial tensor ft (referred to as the first partial tensor ft₁). The first partial tensor ft₁ is written into the second memory 2. Before implementing a convolution operation with respect to the remainder of the first partial tensor as₁ stored in the first memory 1, the quantization operation circuit 5 performs a layer-2M quantization operation corresponding to the first partial tensor ft₁ stored in the second memory 2. The output data from the layer-2M quantization operation is written into the first memory 1. As a result thereof, the first partial tensor ft₁ written into the second memory 2 becomes unnecessary.

Next, the convolution operation circuit 4 reads another portion of the first partial tensor as₁ from the first memory 1 and performs a layer-(2M−1) convolution operation that outputs the partial tensor ft (referred to as the second partial tensor ft₂). The second partial tensor ft₂ is written into the second memory 2. The second partial tensor ft₂ is written over the first partial tensor ft₁. Before implementing a convolution operation with respect to the remainder of the first partial tensor as₁ stored in the first memory 1, the quantization operation circuit 5 performs a layer-2M quantization operation corresponding to the second partial tensor ft₂ stored in the second memory 2. The output data from the layer-2M quantization operation is written into the first memory 1. As a result thereof, the second partial tensor ft₂ written into the second memory 2 becomes unnecessary.

By performing the above-mentioned operations on the remainder of the first partial tensor as₁ from the first memory 1, the layer-(2M−1) convolution operation and the layer-2M convolution operation associated with the first partial tensor as₁ are completed. As a result thereof, the first partial tensor as₁ written into the first memory 1 becomes unnecessary.

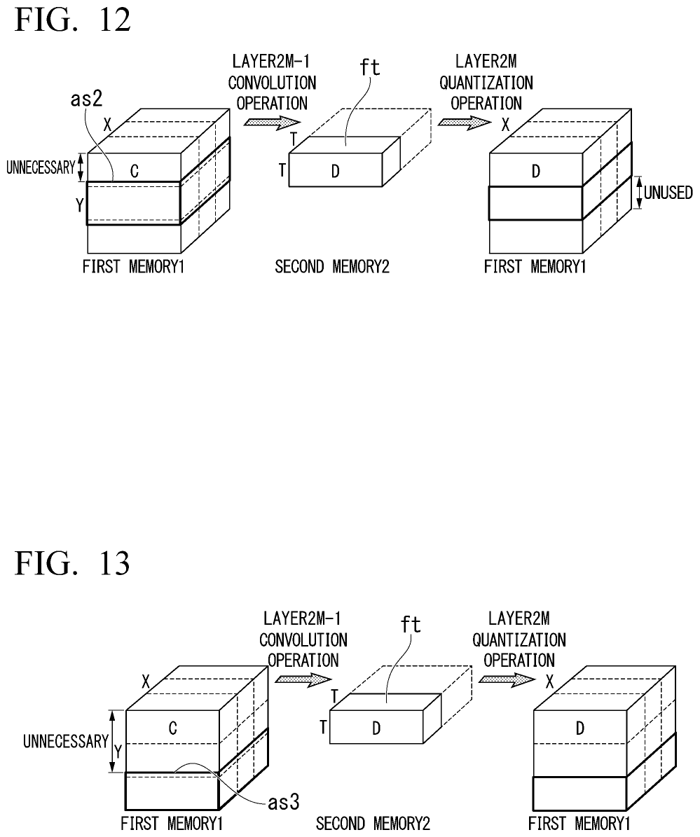

Next, as illustrated in FIG. 12, the convolution operation circuit 4 and the quantization operation circuit 5 similarly implement a convolution operation and a quantization operation with respect to another partial tensor as (second partial tensor as₂) from the first memory 1. The first partial tensor as₁ written into the first memory 1 is unnecessary, and may be overwritten by the output data from the layer-2M quantization operation. When the layer-(2M−1) convolution operation and the layer-2M quantization operation associated with the second partial tensor as₂ are completed, the second partial tensor as₂ written into the first memory 1 becomes unnecessary.

Next, as illustrated in FIG. 13, the convolution operation circuit 4 and the quantization operation circuit 5 similarly implement a convolution operation and a quantization operation with respect to another partial tensor as (third partial tensor as₃) from the first memory 1. The first partial tensor as₁ and the second partial tensor as₂ written into the first memory 1 are unnecessary, and may be overwritten by the output data from the layer-2M quantization operation. When the layer-(2M−1) convolution operation and the layer-2M quantization operation associated with the third partial tensor as₃ are completed, the third partial tensor as₃ written into the first memory 1 becomes unnecessary.

By performing the operations described above on the remainder of the input data a from the first memory 1, the layer-(2M−1) convolution operations and the layer-2M quantization operations are all completed. By partitioning the input data a into slices in this way, the size of the first memory 1 can be reduced in comparison with the example indicated in FIG. 10.

<Convolution Operation Circuit Generation Step (S13-2): Partitioning into Partial Tensors (4)>

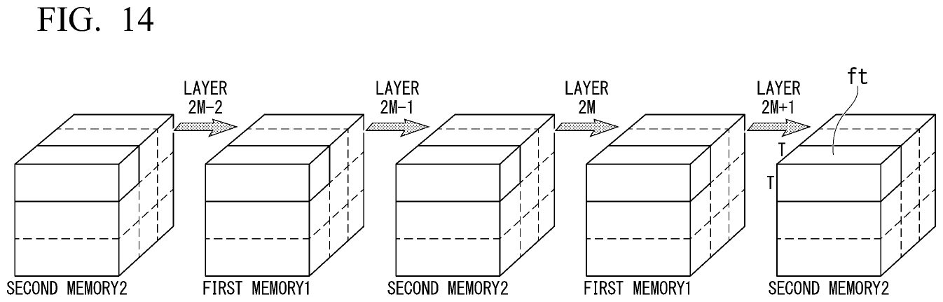

FIG. 14 is a diagram illustrating a partial tensor necessary for outputting another partial tensor ft by a convolution operation in layer (2M+1).

In order to perform the layer-(2M+1) convolution operation and output the partial tensor ft, the partial tensor input to the layer-2M quantization operation is necessary. Furthermore, the partial tensor input to the layer-(2M−1) convolution operation is necessary. Thus, there is a dependency relationship among the partial tensors necessary for outputting the partial tensor ft. The partial tensor ft may be computed by sequentially performing the operations on the partial tensors necessary for outputting the partial tensor ft based on this dependency relationship. The memory sizes of the first memory 1 and the second memory 2 need only be sizes capable of storing the partial tensors, and the overall memory capacity of the first memory 1 and the second memory 2 can be reduced.

The sizes of the various partial tensors mentioned above are set, for example, to sizes such that a prescribed number of partial tensors can be stored in the first memory 1 and the second memory 2. The memory capacities of the first memory 1 and the second memory 2 may be computed from the sizes of the partial tensors.

### <Convolution Operation Circuit Generation Step (S13-2): Hardware Model Generation>

Next, the execution model generation unit 321 generates a hardware model of the convolution operation circuit 4 from information such as the bit widths of the weights w and the input data a that are input as network information NW. The hardware model may be at the behavior level or may be at the RTL (Register Transfer Level), may be a net list indicating connections between gates and circuit modules, or may be a combination thereof. Hereinafter, an example of a hardware model of the convolution operation circuit 4 that is generated will be explained.

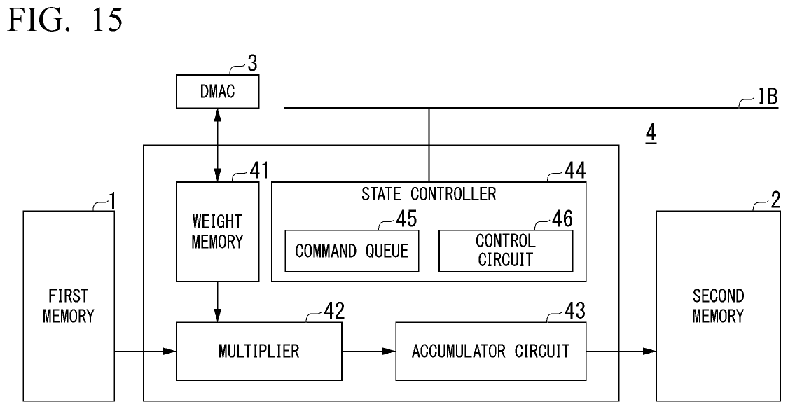

FIG. 15 is an internal block diagram of a generated convolution operation circuit 4.

The convolution operation circuit 4 has a weight memory 41, a multiplier 42, an accumulator circuit 43, and a state controller 44. The convolution operation circuit 4 has a state controller 44 that is dedicated to the multiplier 42 and the accumulator circuit 43 so that, when a command is input, a convolution operation can be implemented without requiring an external controller.

The weight memory 41 is a memory in which weights w used in convolution operations are stored, and may, for example, be a rewritable memory, such as a volatile memory composed of a SRAM (Static RAM) or the like. The DMAC 3 writes the weights w necessary for convolution operations into the weight memory 41 by means of DMA transfer.

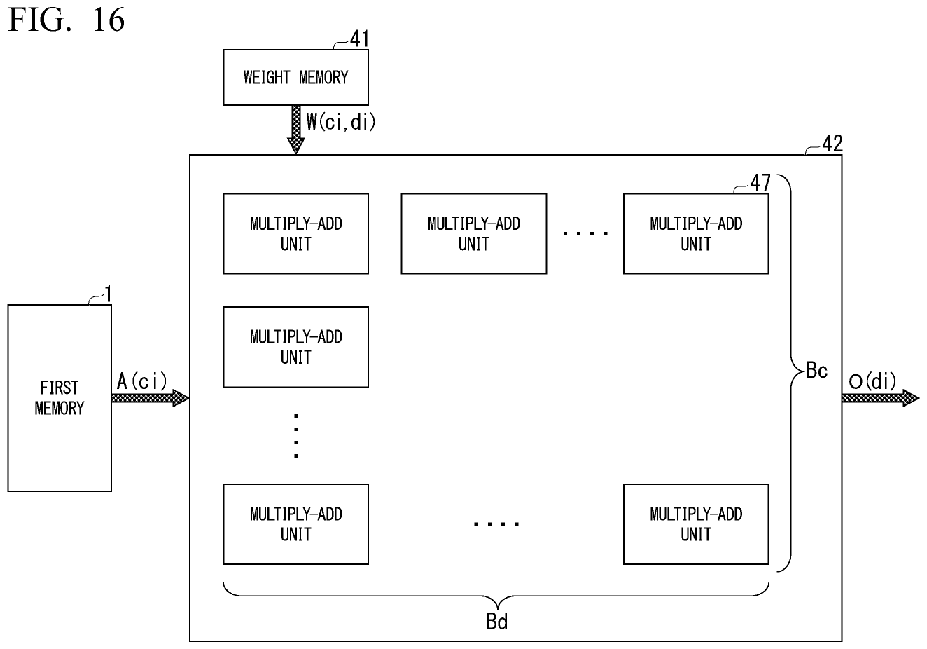

FIG. 16 is an internal block diagram of the multiplier 42.

The multiplier 42 multiplies an input vector A with a weight matrix W. As mentioned above, the input vector A is vector data having Bc elements obtained by expanding partitioned input data a(x+i, y+j, co). Additionally, the weight matrix W is matrix data having Bc×Bd elements obtained by expanding the partitioned weights w(i, j, co, do). The multiplier 42 has Bc×Bd multiply-add operation units 47 and can implement, in parallel, the multiplication of the input vector A with the weight matrix W.

The multiplier 42 implements the multiplication by reading out the input vector A and the weight matrix W necessary for multiplication from the first memory 1 and the weight memory 41. The multiplier 42 outputs Rd multiply-add operation results O(di).

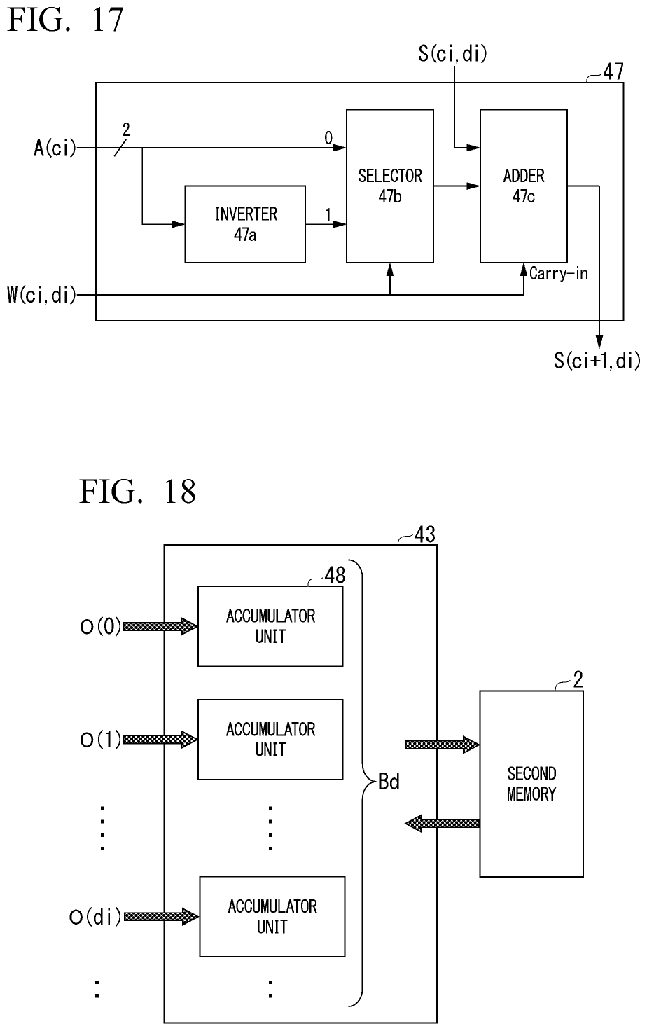

FIG. 17 is an internal block diagram of the multiply-add operation unit 47.

The multiply-add operation unit 47 implements multiplication between the elements A(ci) of the input vector A and the elements W(ci, di) of the weight matrix W. Additionally, the multiply-add operation unit 47 adds the multiplication result with the multiplication results S(ci, di) from other multiply-add operation units 47. The multiply-add operation unit 47 outputs the addition result S(ci+1, di). The elements A(ci) are 2-bit unsigned integers (0, 1, 2, 3). The elements W(ci, di) are 1-bit signed integers (0, 1), where the value “0” represents +1 and the value “1” represents −1.

The multiply-add operation unit 47 has an inverter 47a, a selector 47b, and an adder 47c. The multiply-add operation unit 47 performs multiplication using only the inverter 47a and the selector 47b, without using a multiplier. When the element W(ci, di) is “0”, the selector 47b selects to input the element A(ci). When the element W(ci, di) is “1”, the selector 47b selects a complement obtained by inverting the element A(ci) by means of the inverter. The element W(ci, di) is also input to Carry-in on the adder 47c. When the element W(ci, di) is “0”, the adder 47c outputs a value obtained by adding the element A(ci) to S(ci, di). When W(ci, di) is “1”, the adder 47c outputs a value obtained by subtracting the element A(ci) from S(ci, di).

FIG. 18 is an internal block diagram of the accumulator circuit 43.

The accumulator circuit 43 accumulates, in the second memory 2, the multiply-add operation results O(di) from the multiplier 42. The accumulator circuit 43 has Bd accumulator units 48 and can accumulate Bd multiply-add operation results O(di) in the second memory 2 in parallel.

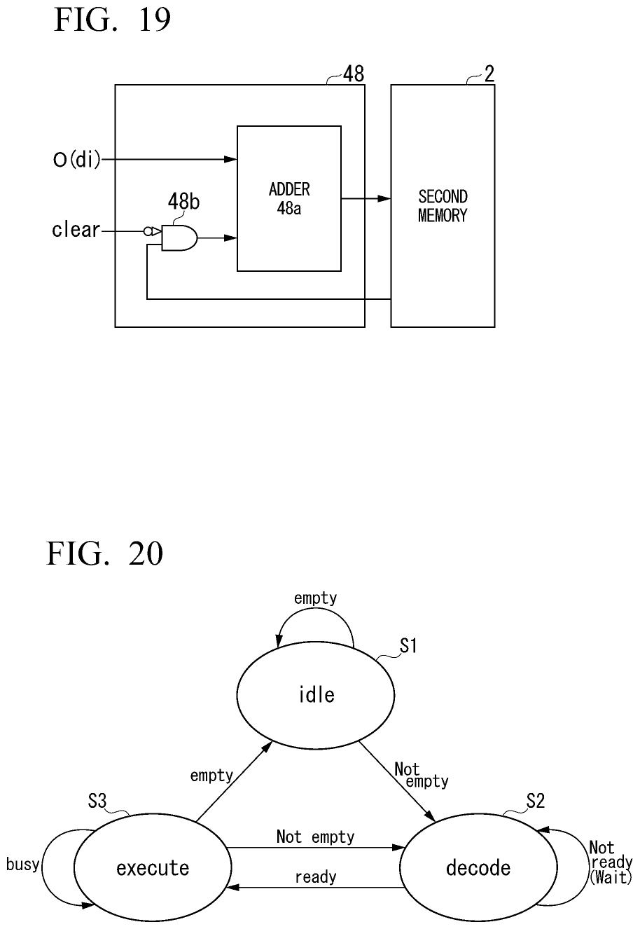

FIG. 19 is an internal block diagram of the accumulator unit 48.

The accumulator unit 48 has an adder 48a and a mask unit 48b. The adder 48a adds an element O(di) of the multiply-add operation results O to a partial sum that is obtained midway through the convolution operation indicated by Equation 1 stored in the second memory 2. The addition results have 16 bits per element. The addition results are not limited to having 16 bits per element, and for example, may have 15 bits or 17 bits per element.

The adder 48a writes the addition results at the same address in the second 5 memory 2. If an initialization signal “clear” is asserted, then the mask unit 48b masks the output from the second memory 2 and sets the value to be added to the element O(di) to zero. The initialization signal “clear” is asserted when the partial sum that is obtained midway is not stored in the second memory 2.

When the convolution operation by the multiplier 42 and the accumulator circuit 43 is completed, output data f(x, y, do) is stored in the second memory 2.

The state controller 44 controls the states of the multiplier 42 and the accumulator circuit 43. Additionally, the state controller 44 is connected to the controller 6 via the internal bus IB. The state controller 44 has a command queue 45 and a control circuit 46.

The command queue 45 is a queue in which commands C4 for the convolution operation circuit 4 are stored, and is constituted, for example, by an FIFO memory. Commands C4 are written into the command queue 45 via the internal bus IB.

The control circuit 46 is a state machine that decodes the commands C4 and that controls the multiplier 42 and the accumulator circuit 43 based on the commands C4. The control circuit 46 may be implemented by a logic circuit, or may be implemented by a CPU controlled by software.

FIG. 20 is a state transition diagram of the control circuit 46.

The control circuit 46 transitions from an idle state S1 to a decoding state S2 when a command C4 is input (Not empty) to the command queue 45.

In the decoding state S2, the control circuit 46 decodes a command C3 output from the command queue 45. Additionally, the control circuit 46 reads semaphores S stored in the register 61 in the controller 6, and determines whether or not operations can be executed in the multiplier 42 and the accumulator circuit 43 instructed by the command C4. If operations cannot be executed (Not ready), then the control circuit 46 waits (Wait) until the operations become executable. If the operations are executable (ready), then the control circuit 46 transitions from the decoding state S2 to an execution state S3.

In the execution state S3, the control circuit 46 controls the multiplier 42 and the accumulator circuit 43 to make the multiplier 42 and the accumulator circuit 43 execute the operations instructed by the command C4. When the operations in the multiplier 42 and the accumulator circuit 43 end, the control circuit 46 removes the command C4 that has been executed from the command queue 45 and updates the semaphores S stored in the register 61 in the controller 6. If there is a command in the command queue 45 (Not empty), then the control circuit 46 transitions from the execution state S3 to the decoding state S2. If there are no commands in the command queue 45 (empty), then the control circuit 46 transitions from the execution state S3 to the idle state S1.

As illustrated in FIG. 16, the execution model generation unit 321 associates the size (Bc or Bd) of the blocks into which the convolution operation data is partitioned with the number (Bc×Bd) of multiply-add units 42. If the size (Bc or Bd) of the blocks into which the convolution operation data from the convolution layers 210 are partitioned is made small, then the hardware size of the multiplier 42 becomes small. However, the operation rate of the multiplier 42 becomes lower.

As illustrated in FIG. 16, an input vector A having Bc elements and a weight matrix W having Bc×Bd elements are input to the multiplier 42. For this reason, even if the number of multiply-add operation units 47 is made greater than Bc×Bd, the multiply-add computation unit 47 cannot be effectively utilized.

The size (Bc or Bd) of the blocks and the size, in the c-axis direction and the d-axis direction, of the input data a and the weights w should preferably be a size that is a power of 2, such as 64, 128 or 256, in order to more efficiently implement division or data integration.

By setting the bit widths of the weights w and input data a that are input as the network information NW to be small, the hardware size of the multiplier 42 and the accumulator circuit 43 can be reduced. Additionally, by setting the bit widths of the weights w and the input data a to be small, the memory capacities of the first memory 1 and the second memory 2 for storing these can be made small. Additionally, the data transfer time to the first memory 1 and the second memory 2 by the DMAC 3 can be shortened.

### <Quantization Operation Circuit Generation Step (S13-3)>

The execution model generation unit 321 generates a quantization operation circuit 5 of the NN execution model 100 based on the hardware information HW and the network information NW (quantization operation circuit generation step). The execution model generation unit 321 generates a hardware model of the quantization operation circuit 5 from quantization information input as network information NW. The hardware model may be at the behavior level or may be at the RTL (Register Transfer Level), may be a net list indicating connections between gates and circuit modules, or may be a combination thereof. Hereinafter, an example of a hardware model of the quantization operation circuit 5 that is generated will be explained.

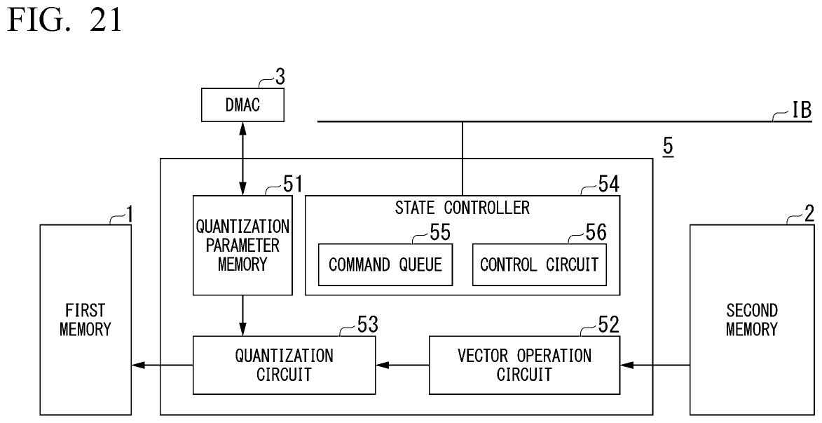

FIG. 21 is an internal block diagram of a generated quantization operation circuit 5.

The quantization operation circuit 5 has a quantization parameter memory 51, a vector operation circuit 52, a quantization circuit 53, and a state controller 54. The quantization operation circuit 5 has a state controller 54 that is dedicated to the vector operation circuit 52 and the quantization circuit 53 so that, when a command is input, a quantization operation can be implemented without requiring an external controller.

The quantization parameter memory 51 is a memory in which quantization parameters q used in quantization operations are stored, and may, for example, be a rewritable memory, such as a volatile memory composed of an SRAM (Static RAM) or the like. The DMAC 3 writes the quantization parameters q necessary for quantization operations into the quantization parameter memory 51 by means of DMA transfer.

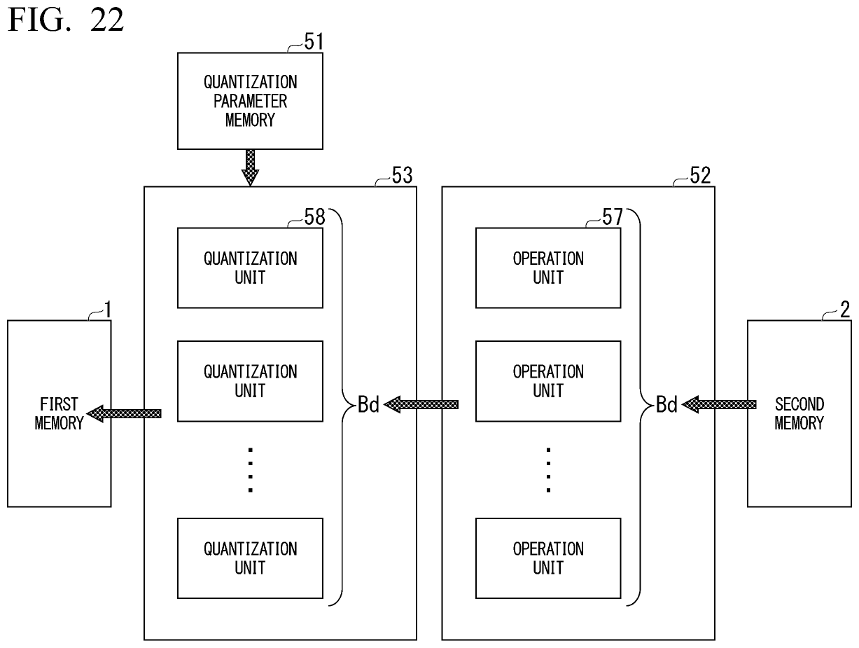

FIG. 22 is an internal block diagram of the vector operation circuit 52 and the quantization circuit 53.

The vector operation circuit 52 performs operations on the output data f(x, y, do) stored in the second memory 2. The vector operation circuit 52 has Bd operation units 57 and performs SIMD operations on the output data f(x, y, do) in parallel.

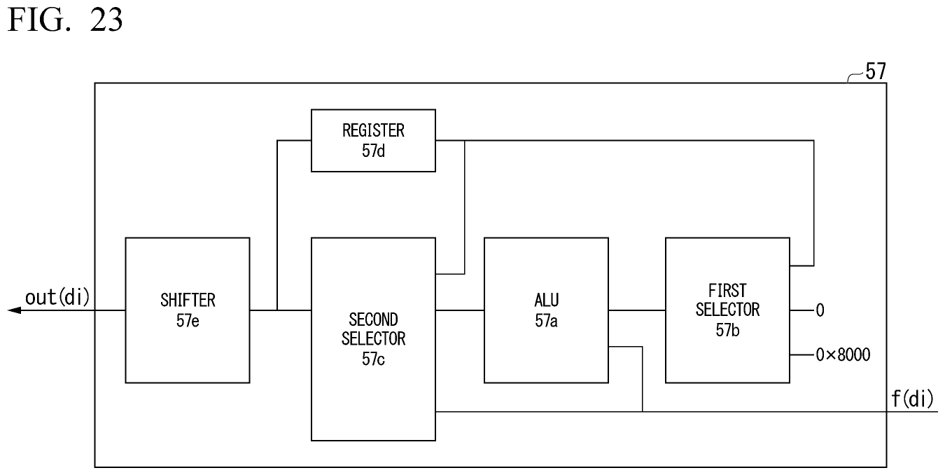

FIG. 23 is a block diagram of an operation unit 57.

The operation unit 57 has, for example, an ALU 57a, a first selector 57b, a second selector 57c, a register 57d, and a shifter 57e. The operation unit 57 may further have other operators or the like that are included in known general-purpose SIMD operation circuits.

The vector operation circuit 52 combines the operators and the like in the operation units 57, thereby performing, on the output data f(x, y, do), the operations of at least one of the pooling layer 221, the batch normalization layer 222, or the activation function layer 223 in the quantization operation layer 220.

The operation unit 57 can use the ALU 57a to add the data stored in the register 57d to an element f(di) in the output data f(x, y, do) read from the second memory 2. The operation unit 57 can store the addition results from the ALU 57a in the register 57d. The operation unit 57 can initialize the addition results by using the first selector 57b to select a “0” as the value to be input to the ALU 57a instead of the data stored in the register 57d. For example, if the pooling region is 2×2, then the shifter 57e can output the average value of the addition results by shifting the output from the ALU 57a two bits to the right. The vector operation circuit 52 can implement the average pooling operation indicated by Equation 2 by having the Bd operation units 57 repeatedly perform the abovementioned operations and the like.

The operation unit 57 can use the ALU 57a to compare the data stored in the register 57d with an element f(di) in the output data f(x, y, do) read from the second memory 2. The operation unit 57 can control the second selector 57c in accordance with the comparison result from the ALU 57a, and can select the larger of the element f(di) and the data stored in the register 57d. The operation unit 57 can initialize the value to be compared so as to be the minimum value that the element f(di) may have by using the first selector 57b to select the minimum value as the value to be input to the ALU 57a. In the present embodiment, the element f(di) is a 16-bit signed integer, and thus, the minimum value that the element f(di) may have is “0x8000”. The vector operation circuit 52 can implement the max pooling operation in Equation 3 by having the Bd operation units 57 repeatedly perform the abovementioned operations and the like. In the max pooling operation, the shifter 57e does not shift the output of the second selector 57c.

The operation unit 57 can use the ALU 57a to perform subtraction between the data stored in the register 57d and an element f(di) in the output data f(x, y, do) read from the second memory 2. The shifter 57e can shift the output of the ALU 57a to the left (i.e., multiplication) or to the right (i.e., division). The vector operation circuit 52 can implement the batch normalization operation in Equation 4 by having the Bd operation units 57 repeatedly perform the abovementioned operations and the like.

The operation unit 57 can use the ALU 57a to compare an element f di) in the output data f(x, y, do) read from the second memory 2 with “0” selected by the first selector 57b. The operation unit 57 can, in accordance with the comparison result in the ALU 57a, select and output either the element f(di) or the constant value “0” prestored in the register 57d. The vector operation circuit 52 can implement the ReLU operation in Equation 5 by having the Bd operation units 57 repeatedly perform the abovementioned operations and the like.

The vector operation circuit 52 can implement average pooling, max pooling, batch normalization, and activation function operations, as well as combinations of these operations. The vector operation circuit 52 can implement general-purpose SIMD operations, and thus may implement other operations necessary for operations in the quantization operation layer 220. Additionally, the vector operation circuit 52 may implement operations other than operations in the quantization operation layer 220.

The quantization operation circuit 5 need not have a vector operation circuit 52. If the quantization operation circuit 5 does not have a vector operation circuit 52, then the output data f(x, y, do) is input to the quantization circuit 53.

The quantization circuit 53 performs quantization of the output data from the vector operation circuit 52. The quantization circuit 53, as illustrated in FIG. 22, has Bd quantization units 58, and performs operations on the output data from the vector operation circuit 52 in parallel.

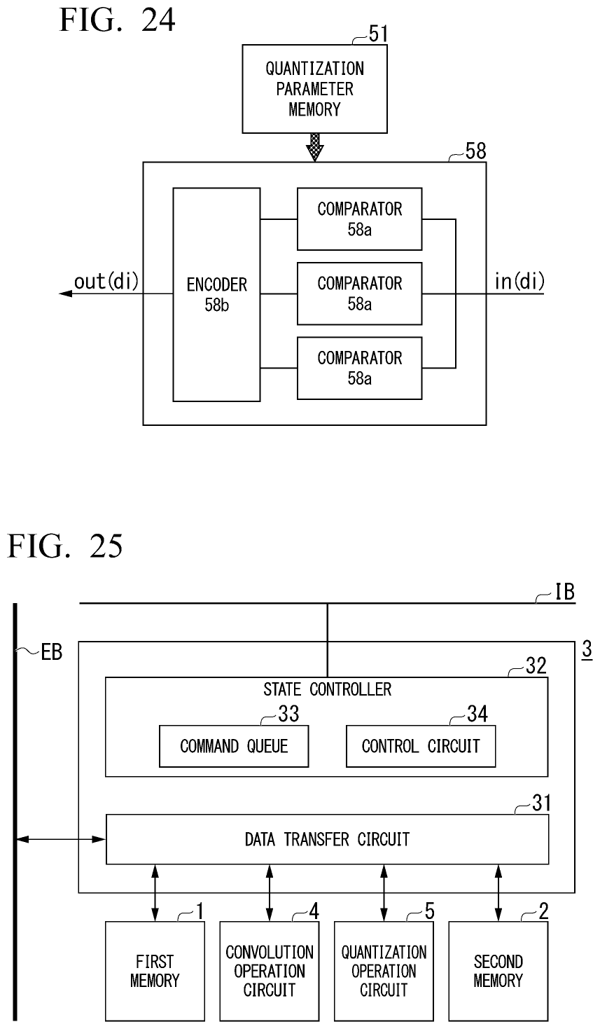

FIG. 24 is an internal block diagram of a quantization unit 58.

The quantization unit 58 performs quantization of an element in(di) in the output data from the vector operation circuit 52. The quantization unit 58 has a comparator 58a and an encoder 58b. The quantization unit 58 performs, on output data (16 bits/element) from the vector operation circuit 52, an operation (Equation 6) of the quantization layer 224 in the quantization operation layer 220. The quantization unit 58 reads the necessary quantization parameter q(th0, th1, th2) from the quantization parameter memory 51 and uses the comparator 58a to compare the input in(di) with the quantization parameter q. The quantization unit 58 uses the encoder 58b to quantize the comparison results from the comparator 58a to 2 bits/element. In Equation 4, α(c) and β(c) are parameters that are different for each variable c. Thus, the quantization parameter q(th0, th1, th2), which reflects α(c) and β(c), is a parameter that is different for each value of in(di).

The quantization unit 58 classifies the input in(di) into one of four regions (for example, in ≤th0, th0<in ≤th1, th1<in ≤th2, th2<in) by comparing the input in(di) with the three threshold values th0, th1 and th2. The classification result is encoded in two bits and output. The quantization unit 58 can also perform batch normalization and activation function operations in addition to quantization in accordance with the setting of the quantization parameter q(th0, th1, th2).

The quantization unit 58 can implement the batch normalization operation indicated in Equation 4 in addition to quantization by performing quantization with the threshold value th0 set to β(c) in Equation 4 and with the differences (th1−th0) and (th2−th1) between the threshold values set to α(c) in Equation 4. The value of α(c) can be made smaller by making (th1−th0) and (th2−th1) larger. The value of α(c) can be made larger by making (th1−th0) and (th2−th1) smaller.

The quantization unit 58 can implement the ReLU operation in the activation function in addition to quantization of the input in(di). For example, the output value of the quantization unit 58 is saturated in the regions where in(di)≤th0 and th2<in(di). The quantization unit 58 can implement the activation function operation in addition to quantization by setting the quantization parameter q so that the output becomes nonlinear.

The state controller 54 controls the states of the vector operation circuit 52 and the quantization circuit 53. Additionally, the state controller 54 is connected to the controller 6 by the internal bus IB. The state controller 54 has a command queue 55 and a control circuit 56.

The command queue 55 is a queue in which commands C5 for the quantization operation circuit 5 are stored, and is constituted, for example, by an FIFO memory. Commands C5 are written into the command queue 55 via the internal bus 1B.

The control circuit 56 is a state machine that decodes commands C5 and that controls the vector operation circuit 52 and the quantization circuit 53 based on the commands C5. The control circuit 56 is configured similarly to the control circuit 46 of the state controller 44 in the convolution operation circuit 4.

The quantization operation circuit 5 writes quantization operation output data having Bd elements into the first memory 1. The preferable relationship between Bd and Bc is indicated by Equation 10. In Equation 10, n is an integer.

Bd=2ⁿ·Bc [Equation 10]

The execution model generation unit 321 determines, from the quantization information input as network information NW, whether or not there are to be pooling operations and the method thereof, whether or not there are to be batch normalization operations and the method thereof, whether or not there are to be activation function operations and the method thereof, the method of quantization, and whether or not there are to be other operations in the quantization operation circuit 5.

For example, if pooling operations are to be performed in the quantization operation circuit 5, then the execution model generation unit 321 generates an operation unit 57 optimized for the type of pooling (average pooling, max pooling, etc.) to be performed.

For example, if activation function operations are to be performed in the quantization operation circuit 5, then the execution model generation unit 321 generates an operation unit 57 or a quantization unit 58 optimized for the activation function (such as a ReLU operation) to be performed.

For example, if batch normalization operations are to be performed in the quantization operation circuit 5, then the execution model generation unit 321 generates an operation unit 57 in accordance with the batch normalization operations. Additionally, the execution model generation unit 321 adjusts the quantization parameter q(th0, th1, th2) in accordance with the batch normalization operations.

For example, if the quantization by the quantization operation circuit 5 is quantization by 3 or more bits, then the execution mode generation unit 321 generates a vector operation circuit 52 that can implement pooling, batch normalization, and scaling for quantization.

For example, in order to reduce the computational load of the quantization 5 operation circuit 5, the normalization operation for batch normalization can be made more efficient. Specifically, in order to use bit shifting in the normalization process for batch normalization, the elements in the input tensors are made powers of 2. In this way, the normalization operation for batch normalization can be realized by bit shifting alone. In this case, an additional operation circuit for converting the elements of the input tensors to powers of 2 may be added to the quantization operation circuit 5, or may be added to the convolution operation circuit 4.

### <DMAC Generation Step (S13-4)>

The execution model generation unit 321 generates the DMAC 3 of the NN execution model 100 based on the hardware information HW and the network information NW (DMAC generation step). The execution model generation unit 321 generates a hardware model of the DMAC 3 from information input as network information NW. The hardware model may be at the behavior level or may be at the RTL (Register Transfer Level), may be a net list indicating connections between gates and circuit modules, or may be a combination thereof. Hereinafter, an example of a hardware model of the DMAC 3 that is generated will be explained.

FIG. 25 is an internal block diagram of a generated DMAC 3.

The DMAC 3 has a data transfer circuit 31 and a state controller 32. The DMAC 3 has a state controller 32 that is dedicated to the data transfer circuit 31 so that, when a command is input, DMA data transfer can be implemented without requiring an external controller.

The data transfer circuit 31 is connected to the external bus EB and performs DMA data transfer between the first memory 1 and an external memory such as a DRAM. Additionally, the data transfer circuit 31 performs DMA data transfer between the second memory 2 and an external memory such as a DRAM. Additionally, the data transfer circuit 31 performs data transfer between the convolution operation circuit 4 and an external memory such as a DRAM. Additionally, the data transfer circuit 31 performs data transfer between the quantization operation circuit 5 and an external memory such as a DRAM. The number of DMA channels in the data transfer circuit 31 is not limited. For example, the data transfer circuit 31 may have a DMA channel dedicated to each of the first memory 1 and the second memory 2.

The state controller 32 controls the state of the data transfer circuit 31. Additionally, the state controller 32 is connected to the controller 6 via the internal bus IB. The state controller 32 has a command queue 33 and a control circuit 34.

The command queue 33 is a queue in which commands C3 for the DMAC 3 are stored, and is constituted, for example, by an FIFO memory. One or more commands C3 are written into the command queue 33 via the internal bus IB.

The control circuit 34 is a state machine that decodes the commands C3 and that sequentially controls the data transfer circuit 31 based on the commands C3. The control circuit 34 is configured similarly to the control circuit 46 of the state controller 44 in the convolution operation circuit 4.

The execution model generation unit 321 determines the number of DMA channels, the data bus width and the like in the DMAC 3 from information input as network information NW.

For example, the execution model generation unit 321 generates a DMAC 3 with specifications (data bus width, etc.) matching the specifications of a host-side external bus EB. By increasing the data bus width and the number of DMA channels, the data transfer rate between the external memory and the first memory 1 and second memory 2 can be increased.

### <Learning Step (S14)>

In step S14, the learning unit 322 and the inference unit 323 of the neural network generating device 300 use the training data set DS to learn the parameters to be learned in the generated NN execution model 100 (learning step). The learning step (S14) has, for example, a learned parameter generation step (S14-1) and an inference testing step (S14-2).

### <Learning Step: Learned Parameter Generation Step (S14-1)>

The learning unit 322 uses the NN execution model 100 and training data D1 to generate learned parameters PM. The learned parameters PM are learned weights w, quantization parameters q and the like.

For example, in the case that the NN execution model 100 is an execution model for a CNN 200 for implementing image recognition, the training data D1 is a combination of an input image and teacher data T. The input image is input data a input to the CNN 200. The teacher data T is the type of an object captured in an image, the presence or absence of a detection target in the image, coordinate values of a detection target in the image, or the like.

The learning unit 322 generates the learned parameters PM by means of teacher-based learning using error backpropagation, which is a known technique, or the like. The learning unit 322 determines a difference E between the output from the NN execution model 100 for an input image and teacher data T corresponding to the input image by means of a loss function (error function), and updates the weight w and the quantization parameter q(th0, th1, th2) so as to make the difference E smaller.

For example, when updating the weight w, the slope of a loss function relating to the weight w is used. The slope is computed, for example, by taking the derivative of the loss function. In the case in which the error backpropagation method is used, the slope is computed by backward propagation.

The learning unit 322, when generating the learned parameters PM, increases the precision of operations associated with convolution operations, operations associated with quantization operations and the like in comparison with the operations implemented by the NN execution model 100.

When computing the slope and updating the weight w, the learning unit 322 increases the precision of operations associated with convolution operations. Specifically, a 32-bit floating-point weight w, which is more precise than the low-bit weight w (e.g., 1 bit) used by the NN execution model 100, is used for training. Additionally, the precision of convolution operations implemented by the convolution operation circuit 4 in the NN execution model 100 is increased.

When computing the slope and updating the weight w, the learning unit 322 increases the precision of operations associated with the activation function. Specifically, a sigmoid function, which is more precise than an activation function such as the ReLU function implemented by the convolution operation circuit 5 in the NN execution model 100, is used for training.

Meanwhile, when the learning unit 322 computes output data with respect to an input image by means of forward propagation, operations based on the NN execution model 100 are implemented without increasing the precision of convolution operations and operations associated with the activation function. The highly precise weights w used when updating the weights w are converted to fewer bits by means of a lookup table or the like.

When computing the slopes and updating the weights w, the learning unit 322 can prevent decreases in the precision of intermediate data in operations by increasing the precision of convolution operations and operations associated with the activation function, thereby generating learned parameters PM by which high inference precision can be realized.

Meanwhile, when computing output data with respect to an input image, the learning unit 322 implements operations based on the NN execution model 100 without increasing the precision of forward propagation operations. For this reason, the output data computed by the learning unit 322 matches the output data from the NN execution model 100 using a learned parameter PM that has been generated.

### <Learning Step: Inference Testing Step (S14-2)>

The inference unit 323 uses the learned parameters PM generated by the learning unit 322, the NN execution model 100 and the test data D2 to implement an inference test. For example, in the case that the NN execution model 100 is an execution model of a CNN 200 for implementing image recognition, the test data D2, like the training data D1, is a combination of an input image and teacher data T.

The inference unit 323 displays the progress and results of the inference test on the display unit 350. The results of the inference test are, for example, the correct answer rate with respect to the test data D2.

### <Confirmation Step (S15)>

In step S15, the inference unit 323 in the neural network generating device 300 displays, on the display unit 350, a message prompting the user to input confirmation of the results by using the manual operation input unit 360 and a GUI image necessary for inputting information. The user inputs, from the manual operation input unit 360, whether or not the results of the inference test are accepted. If an input indicating acceptance of the inference test results has been input from the manual operation input unit 360, then the neural network generating device 300 next implements step S16. If an input indicating that the user does not accept the results of the inference test is input from the manual operation input unit 360, then the neural network generating device 300 implements step S12 again. The neural network generating device 300 may return to step S11 and have the user input the hardware information HW again.

### <Output Step (S16)>

In step S16, the hardware generation unit 324 in the neural network generating device 300 generates a neural network hardware model 400 based on the hardware information HW and the NN execution model 100. Next, the neural network generating device 300 implements step S17 and ends the process.

As explained above, with the neural network generating device 300, the neural network generating method and the neural network generating program according to the present embodiment, it is possible to generate a neural network execution model 100 and a neural network hardware model 400 that are embeddable in an embedded device such as an IoT device, and that generate a neural network that can be made to operate with high performance.

While a first embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Second Embodiment

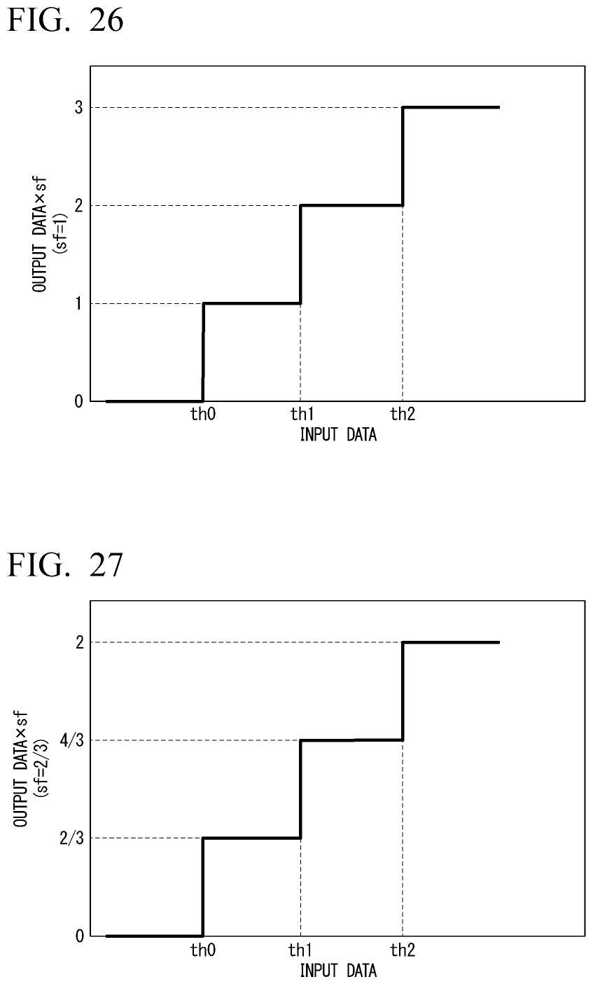

Regarding the neural network generating device 300B according to the second embodiment of the present invention, in the explanation below that will refer to FIG. 26 to FIG. 28, the features that are the same as those that have already been explained will be assigned the same reference numbers and redundant explanations will be omitted. In comparison to the neural network generating device 300 of the first embodiment, the neural network generating device 300B differs only in the learning step (S14-1). Hereinafter, the learning step (S14-1) in the present embodiment will be explained.

### <Learning Step: Learned Parameter Generation Step (S14-1)>

The learning unit 322 uses the NN execution model 100 and training data D1 to generate learned parameters PM. The learned parameters PM are learned weights w, quantization parameters q, scaling factors sf and the like.

The learning unit 322, in addition to learning the quantization parameters q(th0, th1, th2), also learns scaling factors sf (also known as step sizes). The scaling factors sf are factors indicating the scale of quantization operation output data that has been quantized, and are specifically factors that are multiplied with the quantization operation output data.

FIG. 26 to FIG. 28 are diagrams for explaining the scaling factors sf in quantization operations.

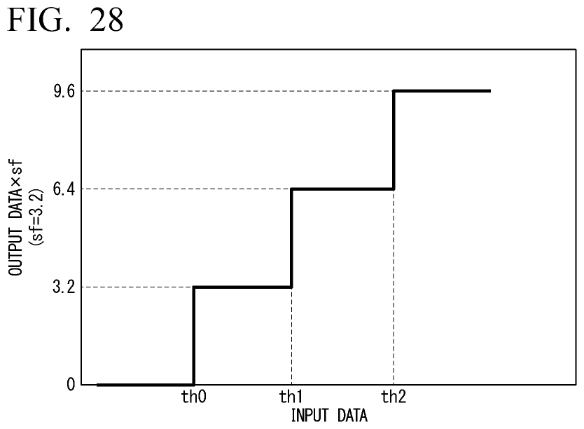

As indicated in FIG. 26, a quantization operation outputs quantization operation output data that has been quantized to 2 bits (0, 1, 2, 3) based on the quantization parameter q(th0, th1, th2). The scaling factor sf is a factor that is multiplied with the quantization operation output data, as illustrated in FIG. 27 and FIG. 28. The quantization parameter q(th0, th1, th2) is a parameter that is appropriate for the range of the input data of the quantization operation, and is a multi-bit parameter having, for example, 8 or more bits.

The learning unit 322 learns the scaling factor sf such that, for example, the range of input data to quantization operations approaches the range of data obtained by multiplying the quantization operation output data with the scaling factor sf. For example, if the range of input data is narrow, then the scaling factor sf becomes small. Additionally, if the range of input data is wide, then the scaling factor sf becomes large. By multiplying the scaling factor sf learned in this way with the quantization operation output data, the learning unit 322 can reduce decreases in precision associated with quantization operations.

The scaling factor sf is a parameter that, for example, is learned for each layer. In this case, the learning unit 322 can learn the optimal scaling factor sf for the range of input data in a quantization operation for each layer. The scaling factor sf is not limited to modes that are learned in each layer, and for example, may be learned for each element O(d).

As in the first embodiment, the learning unit 322 increases the precision of operations associated with convolution operations when generating learned parameters. In the present embodiment, the learning unit 322 uses data obtained by multiplying the scaling factor sf with the quantization operation output data as input data for convolution operations. By applying increased precision of convolution operations and the scaling factor sf to the quantization operation output data, the learning unit 322 can prevent decreased precision of intermediate data during operations and generate learned parameters PM with which higher inference precision can be realized.

Meanwhile, in the NN execution model 100, the quantization operation output data has 2 bits, and the scaling factor sf is not directly multiplied with the quantization operation output data. Thus, in a trained NN execution model 100 (including the NN execution model 100 and the learned parameters PM) used during inference and not during training, the learned scaling factor sf is incorporated into a parameter for another operation. The parameter for another operation is the learned parameters PM or a software parameter for controlling the NN execution model 100, and for example, is the quantization parameter q(th0, th1, th2), an activation function threshold value, a batch normalization parameter, the weight w or the like.

For example, the learned scaling factor sf is incorporated into the quantization parameter q(th0, th1, th2). Specifically, the quantization parameter q(th0, th1, th2) is replaced with a value obtained by dividing the quantization parameter q(th0, th1, th2) by the scaling factor sf.

For example, the learned scaling factor sf is incorporated into a batch normalization parameter. Specifically, a(c) indicated in Equation 4 is replaced by a value obtained by dividing a(c) by the scaling factor sf.

In the CNN 200, there are cases in which the types of operations implemented differ for each layer. For this reason, the learned scaling factor sf is incorporated as a parameter of an operation appropriately selected from among the operations implemented in each layer.

In the present embodiment, an example wherein the learning unit 332 learns a scaling factor sf for quantization operation output data was indicated. The learning unit 332 may utilize a scaling factor for a quantized weight w when using a lookup table or the like to quantize a higher-precision weight w learned in the learning step. The learning unit 332 can learn the scaling factor for the weight w by means of a method similar to the method by which the scaling factor sf is learned for quantization operation output data. Like the scaling factor sf for the quantization operation output data, the scaling factor for the weight w is incorporated into a parameter for another operation.

As explained above, with the neural network generating device 300B, the neural network generating method, and the neural network generating program according to the present embodiment, it is possible to generate a neural network execution model 100 and a neural network hardware model 400 that are embeddable in an embedded device such as an IoT device, and that generate a neural network that can be made to operate with high performance.

While a second embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Modified Example 1

In the above embodiment, the first memory 1 and the second memory 2 were separate memories. However, the first memory 1 and the second memory 2 are not limited to such an embodiment. The first memory 1 and the second memory 2 may, for example, be a first memory area and a second memory area in the same memory.

### Modified Example 2

For example, the data input to the NN execution model 100 described in the above embodiment need not be limited to a single form, and may be composed of still images, moving images, audio, text, numerical values, and combinations thereof. The data input to the NN execution model 100 is not limited to being measurement results from a physical amount measuring device such as an optical sensor, a thermometer, a Global Positioning System (GPS) measuring device, an angular velocity measuring device, a wind speed meter, or the like that may be installed in an edge device in which the neural network hardware model 400 is provided. The data may be combined with different information such as base station information received from a peripheral device by cable or wireless communication, information from vehicles, ships or the like, weather information, peripheral information such as information relating to congestion conditions, financial information, personal information, or the like.

### Modified Example 3

While the edge device in which the NN execution model 100 is provided is contemplated as being a communication device such as a mobile phone or the like driven by a battery or the like, a smart device such as a personal computer, a digital camera, a game device, or a mobile device in a robot product or the like, the edge device is not limited thereto. Effects not obtained by other prior examples can be obtained by utilization in products for which there is a demand for long-term driving or for reducing product heat generation, or for restricting the peak electric power that can be supplied by Power on Ethernet (PoE) or the like. For example, by applying the invention to an on-board camera mounted on a vehicle, a ship, or the like, or to a security camera provided in a public facility or on a road, not only can long-term image capture be realized, but also, the invention can contribute to weight reduction and higher durability. Additionally, similar effects can be achieved by applying the invention to a display device such as a television or a monitor, to a medical device such as a medical camera or a surgical robot, or to a working robot used at a manufacturing site or at a construction site.

A program for an embodiment described above may be recorded on a computer-readable recording medium, and the program recorded on this recording medium may be read into a computer system and executed to realize the embodiment. The “computer system” mentioned here includes an OS and hardware such as peripheral devices. Additionally, the “computer-readable recording medium” refers to a portable medium such as a flexible disk, a magneto-optic disk, a ROM, or a CD-ROM, or to a storage medium such as a hard disk internal to the computer system. Furthermore, the “computer-readable recording medium” may include media that dynamically hold the program for a brief period of time, including communication lines in the case in which the program is transmitted via a network such as the internet and communication lines such as telephone lines, and in those cases, media that hold the program for a certain period of time, such as transitory memory inside the computer system functioning as a server or a client. Additionally, the above-mentioned program may be for realizing a portion of the aforementioned functions, and furthermore, the aforementioned functions may be realized by being combined with a program already stored on the computer system.

Additionally, the effects described in the present specification are merely explanatory or exemplary, and are not limiting. In other words, the features in the present disclosure may, in addition to the effects mentioned above or instead of the effects mentioned above, have other effects that would be clear to a person skilled in the art from the descriptions in the present specification.

### INDUSTRIAL APPLICABILITY

The present invention can be applied to the generation of a neural network.

### REFERENCE SIGNS LIST

300, 300B Neural network generating device
200 Convolutional neural network (CNN)
100 Neural network execution model (NN execution model)
400 Neural network hardware model
1 First memory
2 Second memory
3 DMA controller (DMAC)
4 Convolution operation circuit
42 Multiplier
43 Accumulator circuit
5 Quantization operation circuit
52 Vector operation circuit
53 Quantization circuit
6 Controller
61 Register
PM Learned parameter
DS Training data set
HW Hardware information
NW Network information

1. A neural network generating device that generates a neural network execution model for operating a neural network, the neural network generating device comprising:
an execution model generation unit that generates the neural network execution model based on hardware information regarding hardware in which the neural network execution model is operating and network information regarding the neural network; and
a learning unit that generates learned parameters of the generated neural network execution model.

2. The neural network generating device according to claim 1, further comprising:
a hardware generation unit that generates a neural network hardware model based on the hardware information and the neural network execution model.

3. The neural network generating device according to claim 1, wherein:
the execution model generation unit partitions convolution operations implemented in the neural network execution model based on the generated neural network execution model.

4. The neural network generating device according to claim 1, wherein:
the learning unit performs associated operations implemented when generating the learned parameters with higher precision than operations implemented by the neural network execution model.

5. The neural network generating device according to claim 1, wherein:
the neural network execution model comprises a convolution operation circuit that implements convolution operations and a quantization operation circuit that implements quantization operations.

6. The neural network device according to claim 5, wherein:
the learning unit performs convolution operations implemented when generating the learned parameter with higher precision than operations implemented by the convolution operation circuit.

7. The neural network device according to claim 5, wherein:
the learning unit learns quantization parameters that the quantization operation circuit uses for the quantization operations.

8. The neural network device according to claim 7, wherein:
the learning unit learns a scaling factor for quantization operation output data quantized by the quantization parameters when learning the quantization parameters.

9. A neural network generating method for generating a neural network execution model for operating a neural network, the neural network generating method comprising:
a hardware information acquisition step for acquiring hardware information regarding hardware in which the neural network execution model is operating;
a network information acquisition step for setting network information regarding the neural network;
an execution model generation step for generating the neural network execution model based on the hardware information and the network information; and
a learning step for learning learned parameters of the generated neural network execution model.

10. The neural network generating method according to claim 9, further comprising:
an output step for generating a neural network hardware model based on the hardware information and the neural network execution model.

11. The neural network generating method according to claim 9, wherein:
the execution model generation step involves partitioning convolution operations implemented in the neural network execution model based on the generated neural network execution model.

12. The neural network generating method according to claim 9, wherein:
the learning step involves performing associated operations implemented when generating the learned parameters with higher precision than operations implemented by the neural network execution model.

13. A non-transitory computer-readable recording medium storing a neural network generating program for making a computer generate a neural network execution model for operating a neural network, the neural network generating program comprising:
a hardware information acquisition step for making the computer acquire hardware information regarding hardware in which the neural network execution model is operating;
a network information acquisition step for making the computer set network information regarding the neural network;
an execution model generation step for making the computer generate the neural network execution model based on the hardware information and the network information; and
a learning step for making the computer learn learned parameters of the generated neural network execution model.

14. The non-transitory computer-readable recording medium storing a neural network generating program according to claim 13, further comprising:
an output step for making the computer generate a neural network hardware model based on the hardware information and the neural network execution model.

15. The non-transitory computer-readable recording medium storing a neural network generating program according to claim 13, wherein:
the execution model generation step involves partitioning convolution operations implemented in the neural network execution model based on the generated neural network execution model.

16. The non-transitory computer-readable recording medium storing a neural network generating program according to claim 13, wherein:
the learning step involves performing associated operations implemented when generating the learned parameters with higher precision than operations implemented by the neural network execution model.
